(19) United States
(12) Patent Application Publication
(10) Pub. No.: US 2026/0264878 A1
(43) Pub. Date: Sep. 10, 2026

(54) Additive Manufacturing Composite Rocket Motor Case

(71) Applicant: Northrop Grumman Systems Corporation, Falls Church, VA (US)

(72) Inventor: Talbot P. Thrasher, Newark, DE (US)

(21) Appl. No.: 18/831,366

(22) Filed: Dec. 13, 2024

Related U.S. Application Data
(60) Provisional application No. 63/610,791, filed on Dec. 15, 2023.

(51) Int. Cl. B64F 5/10; B33Y 80/00; B64G 1/00; B64G 1/40; F02K 9/34

(52) U.S. Cl. CPC B64F 5/10; B33Y 80/00; B64G 1/002; B64G 1/403; F02K 9/34

(57) ABSTRACT

A method of manufacturing a rocket motor includes fabricating a forward dome from a first fiber reinforced thermoplastic to define a cylindrical portion and a hemispherical portion extending from the cylindrical portion, assembling the forward dome on a mandrel, and forming a composite case from a second fiber reinforced thermoplastic over the mandrel and at least a portion of each of the forward dome, where at least a portion of the first fiber reinforced thermoplastic of the forward dome is consolidated with at least a portion of the second fiber reinforce thermoplastic of the composite case to define a unitary interface.

### CROSS REFERENCE TO RELATED APPLICATIONS

This application claims the benefit of U.S. Provisional Patent Application No. 63/610,791, filed Dec. 15, 2023, entitled ADDITIVE MANUFACTURING COMPOSITE ROCKET MOTOR CASE, the contents of which are expressly incorporated herein by reference.

### TECHNICAL FIELD

Systems and techniques for additive manufacturing fabrication of rocket motors using thermoplastic matrix composite structural components which are selectively integrated to define a unitary case and domes.

### BACKGROUND

Composite rocket motor cases are typically fabricated by winding thermoset polymer impregnated filaments over a mandrel, oven curing the wound composite case, and bonding domes, skirts, and lugs to the cured composite case. Generally, these techniques are tooling and capital intensive, with added time for composite curing and post processing steps. Such methods are not capable of production rates to meet the increasing demand for rocket motors, such as hypersonic rocket motors.

### SUMMARY

The present disclosure is directed systems and techniques for parallel fabrication of composite rocket motor case components using continuous fiber additive manufacturing processes and selective integration of components to produce the complete rocket motor with a unitary case and domes. The disclosed systems and techniques enable a high-rate, low-cost fabrication of rocket motor cases compared to other fabrication methods. For example, the described systems and techniques provide a fabrication cost savings of approximately 50% and a fabrication time savings of about 50% compared to typical methods. Moreover, the systems and techniques enable improved integration of components during the fabrication process.

In some examples, a technique for manufacturing a rocket motor includes winding onto a first mandrel, a first fiber reinforced thermoplastic to define a dome. The technique also includes assembling the dome on a second mandrel to define an assembly. The technique also includes winding onto the assembly, by automated consolidating filament tape winding with at least two opposing heads, a second fiber reinforced thermoplastic to define a composite case. The at least two opposing heads are configured to apply an equally opposing force moment on the second mandrel. After winding the second fiber reinforced thermoplastic, at least a portion of the second fiber reinforced thermoplastic is consolidated with at least a portion of the first fiber reinforced thermoplastic to define a unitary interface between the dome and the composite case.

In some examples, a technique for manufacturing a rocket motor includes fabricating a forward dome including a first fiber reinforced thermoplastic. The forward dome includes a cylindrical portion and a hemispherical portion extending from the cylindrical portion. The technique also includes assembling the forward dome on a mandrel. The technique also includes forming a composite case including a second fiber reinforced thermoplastic on the mandrel and over at least a portion of the forward dome. At least a portion of the first fiber reinforced thermoplastic of the forward dome is consolidated with at least a portion of the second fiber reinforce thermoplastic of the composite case to define a unitary interface.

In some examples, a composite rocket case includes a dome formed from a first wound fiber reinforced thermoplastic and a composite case formed from a second wound fiber reinforced thermoplastic defining a hollow cylinder extending from a proximal end to a distal end. At least a first portion of the third wound fiber reinforced thermoplastic at the proximal end is consolidated with a portion of the first wound fiber reinforced thermoplastic to define a first unitary interface between the dome and the composite case.

In some examples, a technique for manufacturing a rocket motor includes winding onto a first mandrel, a first fiber reinforced thermoplastic to define an aft dome. The technique also includes winding onto a second mandrel, a second fiber reinforced thermoplastic to define a forward dome. The technique also includes three-dimensional printing of a high strength metal or alloy to define at least one attachment feature. The technique also includes assembling the aft dome, the forward dome, and the at least one attachment feature on a third mandrel to define an assembly. The technique also includes winding onto the assembly, a third fiber reinforced thermoplastic to define a composite case. At least a first portion of the third fiber reinforced thermoplastic is consolidated with at least a portion of the first fiber reinforced thermoplastic to define a first unitary interface between the aft dome and the composite case. At least a second portion of the third fiber reinforced thermoplastic is consolidated with at least a portion of the second fiber reinforced thermoplastic to define a second unitary interface between the forward dome and the composite case.

In some examples, a technique for manufacturing a rocket motor includes fabricating a forward dome from a first fiber reinforced thermoplastic. The forward dome includes a cylindrical portion and a hemispherical portion extending from the cylindrical portion. The technique also includes assembling the forward dome on a mandrel. The technique also includes forming a composite case from a second fiber reinforced thermoplastic over at least a portion of the forward dome. At least a portion of the first fiber reinforced thermoplastic of the forward dome is consolidated with at least a portion of the second fiber reinforce thermoplastic of the composite case to define a unitary interface.

In some examples, a composite rocket case includes an aft dome having a first wound fiber reinforced thermoplastic, a forward dome having a second wound fiber reinforced thermoplastic, and a composite case having a third wound fiber reinforced thermoplastic. The composite case defines a hollow cylinder extending from a proximal end to a distal end. At least a first portion of the third wound fiber reinforced thermoplastic at the proximal end is consolidated with at least a portion of the first wound fiber reinforced thermoplastic to define a first unitary interface between the aft dome and the composite case. At least a second portion of the third wound fiber reinforced thermoplastic at the distal end is consolidated with at least a portion of the second wound fiber reinforced thermoplastic to define a second unitary interface between the forward dome and the composite case.

### BRIEF DESCRIPTION OF THE DRAWINGS

The disclosure can be understood in consideration of the following detailed description of various embodiments in connection with the accompanying drawings.

FIG. 1 is a conceptual diagram of an example vehicle including a rocket motor.

FIG. 2 is a conceptual diagram illustrating a cross-sectional view of an example rocket motor.

FIGS. 3A through 3H are conceptual diagrams illustrating example components of a rocket motor.

FIG. 4 is a conceptual diagram illustrating an example system for manufacturing an example rocket motor.

FIG. 5 is a conceptual diagram illustrating an example automated robot for fabricating components of a rocket motor.

FIG. 6 is a conceptual diagram illustrating an example material deposition device for fabricating components of a rocket motor.

FIGS. 7A through 7C are conceptual diagrams illustrating an example insulator station configured to fabricate an insulator of a rocket motor.

FIGS. 8A through 8C are conceptual diagrams illustrating an example aft dome station configured to fabricate an aft dome of a rocket motor.

FIGS. 9A through 9C are conceptual diagrams illustrating an example forward dome station configured to fabricate a forward dome of a rocket motor.

FIGS. 10A through 10D are conceptual diagrams illustrating an example composite case station configured to fabricate a composite case of a rocket motor.

FIG. 11 is a flow diagram illustrating an example technique for manufacturing a rocket motor including a composite case and end domes which define a unitary interface.

FIG. 12 is a flow diagram illustrating an example technique for manufacturing a rocket motor including a composite case and end domes which define a unitary interface.

FIG. 13 is a flow diagram illustrating an example technique for manufacturing a rocket motor including a composite case and end domes which define a unitary interface.

### DETAILED DESCRIPTION

For purposes of promoting an understanding of the principles of the disclosure, reference will now be made to the embodiments illustrated in the drawings, and specific language will be used to describe the same. It will nonetheless be understood that no limitation of the scope of the disclosure is intended by the illustration and description of certain embodiments of the disclosure. In addition, any alterations and/or modifications of the illustrated and/or described embodiments are contemplated as being within the scope of the present disclosure. Further, any other applications of the principles of the disclosure, as illustrated and/or described herein, as would normally occur to one skilled in the art to which the disclosure pertains, are contemplated as being within the scope of the present disclosure.

The present disclosure is directed systems and techniques for parallel fabrication of composite rocket motor case components using continuous fiber additive manufacturing processes and selective integration of components to produce a rocket motor assembly having a unitary case and domes. The systems and techniques disclosed herein for fabricating rocket motor cases enable a high-rate, low-cost fabrication with the described additive manufacturing technique and improved integration of rocket motor components compared to other fabrication methods.

Other conventional filament wound pressure vessel fabrication methods use single-yarn or coordinated-multi-yarn windings with fibers such as fiberglass, polyester, carbon, or Kevlar prepregnated with epoxy, vinyl ester, or other thermoset resins. Post processing of such thermoset resins may include application of vacuum to remove voids in the resin and heat treatment or other curing steps to promote crosslinking of the resin. Once cured, thermoset resins are generally more brittle than thermoplastic polymers. For rocket motor fabrication using conventional methods, end skirts and additional structures are bonded to wound components with additional thermoset resins because such additional structures are difficult to integrate during winding with thermoset resins.

To overcome these and other deficiencies, example techniques disclosed herein include separately forming at least one of an aft dome and a forward dome, an optional insulator, and at least one optional attachment feature such as a lug, enclosures, skirt, strakes, fins, raceways, initiators, actuators, embedded sensors, or the like. The aft dome, forward dome and optional insulator, may be formed on separate mandrels that enable the aft dome and forward dome to be indexed to the insulator and/or an indexing mandrel. The aft dome and the forward dome may be formed with respective aft and forward insulator layers. The optional attachment features may be formed by additive manufacturing using a high strength metal alloy and positioned at one or more selected locations on the optional insulator or indexing mandrel. During assembly, before application of the composite case overlayer, optional aft and forward brackets may be positioned near the interface of the optional insulator or indexing mandrel and the respective aft and forward dome to facilitate alignment and strengthen the ends of the rocket motor.

Once the aft dome, forward dome and optional insulator are assembled, a composite case including a fiber reinforced thermoplastic may be formed over at least a portion of the aft dome and forward dome. The aft dome and forward dome include at least one layer of fiber reinforced thermoplastic material that integrally forms with and is inherently bonded to the fiber reinforced thermoplastic of the composite case. This enables in-situ consolidation of the composite case over and integral with the domes. Further, the respective unitary interfaces of the aft dome and the forward dome with the composite case may not have bond lines, which improve stress transition at the respective unitary interfaces. The attachment features may include a surface texture that is configured to physically and adhesively bond to the composite case overlayer. Other optional components may be added during the composite case winding process such that the optional components are at least partially embedded within one or more layers of the composite case.

The systems and techniques disclosed herein provide several advantages over conventional systems and methods. For example, because a parent material of the composite case is consolidated with a parent material of the aft dome and forward dome, intermediate bonding of the domes to the case is eliminated and provides a stronger interface having a unitary thermoplastic matrix. Moreover, the technique enhances configurability of rocket motor components compared to other fabrication methods, such as processes using thermoset resins. Such integrated fabrication and assembly in an optimized series configuration, also supports a versatile manufacturing line thlat can produce multiple varied rocket motor configurations at rates greater than those possible with conventional methods. Additionally, by decoupling fabrication of at least the insulator, aft and forward domes, lugs, and other optional components, the component parts of the rocket motor may be fabricated within discrete component fabrication stations with appropriate station size and filament width for select part configurations, which enables higher material lay-down rates compared to other techniques and assembly-line production with an approximately two-to four-hour tack time to produce a fully insulted rocket motor case ready for propellant.

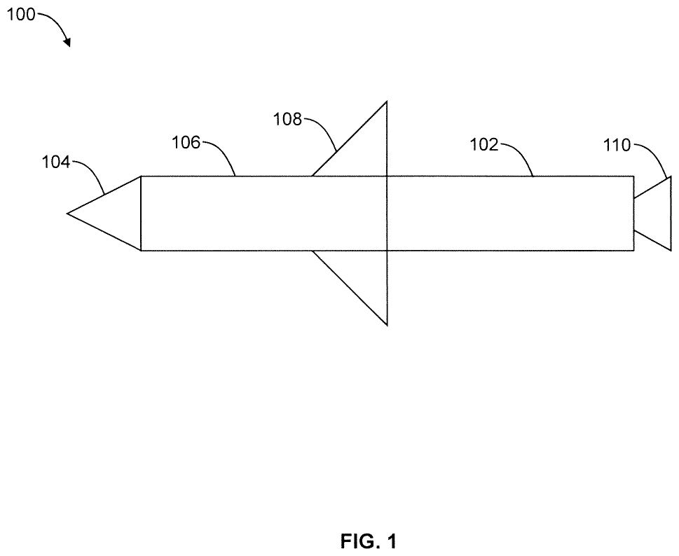

FIG. 1 is a conceptual diagram of an example vehicle 100 including a rocket motor 102. Vehicle 100 may include an aerospace vehicle or a munition. At least a portion of the propulsion of vehicle 100 is generated by rocket motor 102.

Rocket motor 102 includes a case that houses an energetic fuel, which may also be characterized as a propellant. An insulation and an optional liner protect the case interior from thermal and erosive effects of particle streams generated by combustion of the propellant. In some examples, rocket motor 102 includes a solid propellant rocket motor. In other examples, rocket motor 102 may include other types of rocket motors, such as hybrid, reverse hybrid, biliquid, motor-propelled, or the like. Vehicle 100 may include other propulsion units such as one or more rocket motor stages, auxiliary propulsion unit, or the like.

During operation, combustion products generated by combustion of the propellant are directed through exit cone 110 which includes a nozzle operatively associated with the case to receive and to expel the combustion products, generating thrust to propel rocket motor 102 and associated vehicle 100. The case and insulation are fabricated from compositions that are capable of enduring the extreme temperature, pressure, turbulence conditions, and ablative or erosive particles produced within the case during combustion of the propellant. In some examples, the environment inside the case may reach a temperature of approximately 2760° C. (about 5000° F.), a pressure of approximately 1500 pounds per square inch (psi) (approximately 10.3 mega-Pascal (MPa)), and gas/particle velocities in excess of Mach 0.2. These conditions, along with a restrictive throat region of the nozzle provided along a passageway between the case and the nozzle, combine to create a high degree of turbulence within the case. In addition, the gases produced during combustion of the propellant contain high-energy particles that, under a turbulent environment, erode the insulation. If the propellant penetrates through the insulation, the case may melt, be eroded, or otherwise be compromised, causing the rocket motor to fail.

Depending on the configuration of rocket motor 120, various combinations of mechanical, thermal, and ablative properties are desired in different sections of rocket motor 102. For some sections, high elongation properties are desirable while for other sections, good ablation and/or good mechanical properties are desirable. Some sections benefit from good electrostatic discharge (ESD) properties, while other sections benefit from good insulative properties.

Vehicle 100 also includes a nose section 104, a payload section 106, and control surfaces 108. Nose section 104 may include devices configured to control an operation of vehicle 100, such as, for example, a guidance system, communication circuitry, or the like. Payload section 106 may include one or more of the devices configured to control the operation of vehicle 100. In some examples, payload section 106 may include a warhead or other devices. Control surfaces 108 are configured to steer vehicle 100 while in flight. Although illustrated as extending from payload section 106, in other examples, control surfaces 108 may extend from other portions of vehicle 100 and/or vehicle 100 may include additional control surfaces.

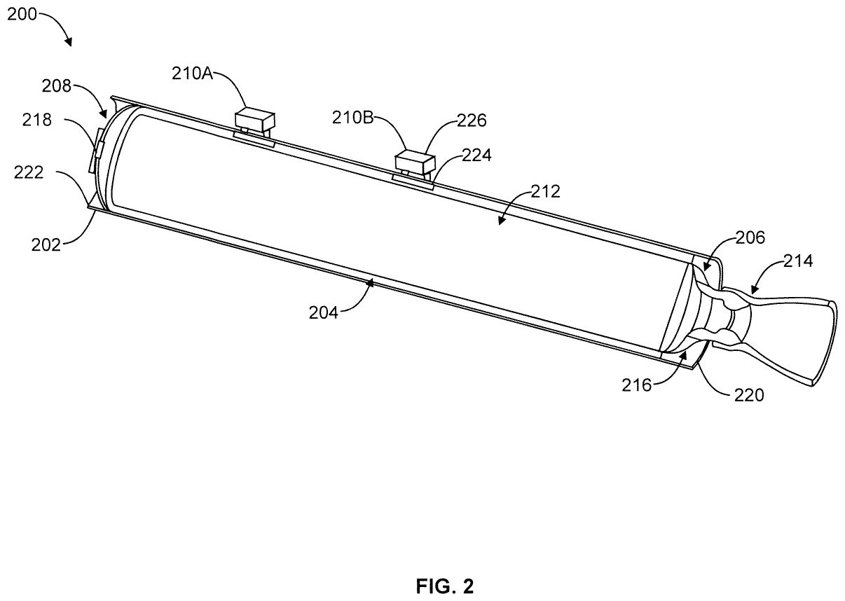

FIG. 2 is a conceptual diagram illustrating a cross-sectional view of an example rocket motor 200. Rocket motor 200 may be the same as or substantially similar to rocket motor 102 described above in reference to FIG. 1, except for the differences described herein. Rocket motor 200 includes a composite case 202, an insulator 204, an aft dome 206, a forward dome 208, and attachment features 210A and 210B (collectively, attachment features 210). Composite case 202 includes a fiber reinforced thermoplastic that is configured to integrate with materials of assembled components of rocket motor 200 including insulator 204, aft dome 206, forward dome 208, and attachment features 210. For example, aft dome 206 and forward dome 208 may include at least one fiber reinformed thermoplastic layer configured to consolidate with an overlayed fiber reinformed thermoplastic of composite case 202 to form a unitary thermoplastic matrix.

Composite case 202 includes a hollow cylinder extending from a proximal end 220 to a distal end 222. To contain the pressure produced during operation of rocket motor 200 and to protect other components of rocket motor 200 during storage, transport, and operation of rocket motor 200 from external impacts, drops, and environmental factors, composite case 202 includes a fiber reinforced thermoplastic composite material.

The fiber of the composite material may include any fiber having a suitable tensile strength, specific strength (i.e., strength-to-weight ratio), Young's modulus, or combination thereof. Example values may include at least one of a fiber tensile strength greater than approximately 1000 MPa, specific strength greater than approximately 1000 kN-m/kg, Young's modulus greater than approximately 3 GPa. Example fibers include, but are not limited to, acrylamide fibers, aramid fibers, basalt fibers, carbon fibers, silica fibers, glass fibers, Kevlar®, polybenzamide fibers, polybenzimidazole fibers, or polybenzoxazole fibers.

The thermoplastic of the composite material may include any thermoplastic having a suitable tensile strength, density, or Young's modulus. Example values may include at least one of a tensile strength greater than about 50 MPa, a specific gravity less than approximately 2, and a Young's modulus greater than approximately 2 GPa. Example thermoplastics include, but are not limited to, polyether ether ketone (PEEK), polycarbonates (PC), polyacrylates (PA), and fluoropolymers.

Composite case 202 may be formed in whole or in part using any suitable additive manufacture technique for pressure vessels that enables in-situ consolidation of the thermoplastic material. In-situ consolidation techniques include heating a tape and/or a previously placed layer to at least partially melt the thermoplastic as the tape is placed onto a tool and/or a previously placed layer. The at least partially melted thermoplastic may be set with pressure applied to the tape, via pressure applied by a roller or an armature, or both. As such, voids between adjacent layers may be eliminated or substantially reduced. For example, a porosity of the composite case 202 may be less than approximately 1%, such as less than approximately 0.5% or less than approximately 0.2%. In some examples, pairs of opposing rollers or armatures may be configured to apply the pressure for consolidation with an equally opposing force moment on the composite case 202 being formed (or mandrel). In some examples, the technique may include automated consolidating filament tape winding. Compared to techniques using thermoset polymers, in-situ consolidation of fiber reinforced thermoplastics eliminates at least one of consolidation and void removal by application of vacuum, thermal processing in an autoclave, oven, or heated tool, and curing for completion of crosslinking reactions. In these ways, the described composite case 202 may be fabricated faster and less expensively compared to other methods.

In some examples, at least a portion of composite case 202 may be formed using techniques described in commonly assigned U.S. Pat. No. 4,118,262, entitled “Longitudinal Load Carrying Method for Fiber Reinforced Filament Wound Structures,” filed May 21, 1976; and U.S. Pat. No. 7,216,327, entitled “Apparatus and Method for Reinforcing a Pressure Vessel,” filed Dec. 8, 2003; the entirety of each of which are incorporated herein by reference.

Insulator 204 includes a hollow cylinder defining a cavity configured to receive therein a propellant 212. An optional liner may be disposed between the insulator 204 and propellant 212. Nozzle 214 is operatively coupled to composite case 202 and/or aft dome 206 and configured to receive combustion products generated by combustion of propellant 212 and to expel the combustion products, generating thrust to propel the rocket motor 200. Methods for loading propellant 212 are known in the art and, therefore, are not described in detail herein.

Propellant 212 may include a solid propellant. Example solid propellants include, but are not limited to, propellants described in Thakre et al., Solid Propellants, Rocket Propulsion, Vol. 2, Encyclopedia of Aerospace Engineering, John Wiley & Sons, Ltd. 2010, the entire disclosure of which is incorporated herein by reference. The propellant 212 may be a class 4.1, 1.4, or 1.3 material, as defined by the United States Department of Transportation shipping classification, so that transportation restrictions are minimized. By way of non-limiting example, propellant 212 may be formed of and include a polymer having one or more of a fuel and an oxidizer incorporated therein. The polymer may be an energetic polymer or a non-energetic polymer, such as glycidyl nitrate (GLYN), nitratomethylmethyloxetane (NMMO), glycidyl azide (GAP), diethyleneglycol tri ethyleneglycol nitraminodiacetic acid terpolymer (9DT-NIDA), bis(azidomethyl)-oxetane (BAMO), azidomethylmethyl-oxetane (AMMO), nitraminomethyl methyloxetane (NAMMO), bis(difluoroaminomethyl)oxetane (BFMO), difluoroaminomethylmethyloxetane (DFMO), copolymers thereof, cellulose acetate, cellulose acetate butyrate (CAB), nitrocellulose, polyamide (nylon), polyester, polyethylene, polypropylene, polystyrene, polycarbonate, a polyacrylate, a wax, a hydroxyl-terminated polybutadiene (HTPB), a hydroxyl-terminated poly-ether (HTPE), carboxyl-terminated polybutadiene (CTPB) and carboxyl-terminated polyether (CTPE), diaminoazoxy furazan (DAAF), 2,6-bis(picrylamino)-3,5-dinitropyridine (PYX), a polybutadiene acrylonitrile/acrylic acid copolymer binder (PBAN), polyvinyl chloride (PVC), ethylmethacrylate, acrylonitrile-butadiene-styrene (ABS), a fluoropolymer, polyvinyl alcohol (PVA), or combinations thereof. The polymer may function as a binder, within which one or more of the fuel and oxidizer is dispersed. The fuel may be a metal, such as aluminum, nickel, magnesium, silicon, boron, beryllium, zirconium, hafnium, zinc, tungsten, molybdenum, copper, or titanium, or alloys mixtures or compounds thereof, such as aluminum hydride (AIH3), magnesium hydride (Mgfh), or borane compounds (BH₃). The metal may be used in powder form. The oxidizer may be an inorganic perchlorate, such as ammonium perchlorate or potassium perchlorate, or an inorganic nitrate, such as ammonium nitrate or potassium nitrate. Other oxidizers may also be used, such as hydroxylammonium nitrate (HAN), ammonium dinitramide (ADN), hydrazinium nitroformate, anitramine, such as cyclotetramethylene tetranitramine (HMX), cyclotrimethylene trinitramine (RDX), 2,4,6,8,10,12-hexanitro-2,4,6,8,10,12-hexaazaisowurtzitane (CL-20 or HNIW), and/or 4,10-dinitro-2,6,8,12-tetraoxa-4,10-diazatetracyclo-[5.5.0.05 9.0 3 11]-dodecane (TEX). In addition, the propellant 212 may include additional components, such as one or more of a plasticizer, a bonding agent, a combustion rate modifier, a ballistic modifier, a cure catalyst, an antioxidant, and a pot life extender, depending on the desired properties of the propellant. These additional components are well known in the rocket motor art and, therefore, are not described in detail herein. The components of the propellant of the propellant 212 may be combined by conventional techniques, which are not described in detail herein.

During operation of rocket motor 200, insulator 204 protects components, such as composite case 202, aft dome 206, and forward dome 208, from heat and particle streams that are generated by propellant 212. While the insulator 204 is shown as being internal to composite case 202, in other examples, insulator 204 or insulating regions that are substantially the same as or similar to insulator 204 may be used on other portions of rocket motor 200, either internally, externally, or both. For example, insulator 204 may provide ablative protection to an external bulk of composite case 202 and nozzle 214.

Insulator 204 may include any suitable material, combination of materials, or a composite, such as a fiber-matrix or a particle-matrix composite system, which are configured to resist thermal degradation and ablation by hot particles during burn of propellant 212. In some examples, a matrix of insulator 204 includes ethylene propylene diene terpolymer (EPDM), ethylene acrylic elastomer, neoprene, fluoroelastomer, silicon, or other materials configured to resist thermal degradation for at least a selected amount of time, such as a desired flight time of rocket 200. In some examples, a fiber or a particle of insulator 204 includes carbon fibers, silica, fibers, aramid fibers, Kevlar, or silica powder. Example insulator 204 materials are described in commonly assigned U.S. Pat. No. 6,566,420, entitled “EPDM Rocket Motor Insulation,” filed Jan. 12, 2000; U.S. Pat. No. 7,410,607, entitled “Method of Insulating a Case of a Solid Propellant Rocket Motor,” filed Sep. 10, 2004; U.S. Pat. No. 7,070,705, entitled “Fiber-Reinforced Rocket Motor Insulation,” filed Feb. 5, 2004; U.S. Pat. No. 10,612,249, entitled “Precursor Compositions for an Insulation, Insulated Rocket Motors, and Related Methods,” filed Mar. 16, 2017; U.S. Patent Application No. 2023/028784, entitled “Precursor Compositions for an Insulation and Related Methods,” filed Dec. 12, 2022; the entirety of each of which are incorporated herein by reference.

Insulator 204 may be formed using any suitable method. In some examples, insulator 204 may be formed by winding an EPDM-based Kevlar® felt wet tape onto a mandrel. For example, a 1-inch (2.54-centimeter (cm)) strip of Kevlar® felt tape may be impregnated with the EPDM-based material via an extruder and inline calendar. The impregnated wet tape then may be applied to a mandrel under a desired tension or pressure and patterning. In some examples, the impregnated wet tape may be applied in a shingle wrap configuration. This technique enables EPDM to be online vulcanized and impregnated into the Kevlar® felt tape. In some examples, a scrim layer of additional wet material, such as a 1-inch (2.54 cm) strip of material, may be applied prior to the impregnated wet tape directly on the mandrel, in-between plies during a felting/needle stich process, or both. After placement, the EPDM-based material is cured. Once cured, the cured tape may be machined on the mandrel, e.g., via lathe or similar process, to a selected surface profile. The completed insulator 204 is then ready to receive other components for assembly.

Aft dome 206 includes a cylindrical portion and a hemispherical portion. The cylindrical portion defines a cavity configured to receive therein at least a portion of the insulator 204. The hemispherical portion defines a doubly curved surface terminating in or otherwise defining an aperture within a plane that is normal to a longitudinal axis of rocket motor 200.

In some examples, the hemispherical portion is coupled to a closure ring 216 which defines the aperture. Closure ring 216 is configured to receive therethrough a cartridge of propellant 212 and couple to nozzle 214. Additionally, closure ring 216 may be configured to couple to a tooling fixture during assembly of rocket 200, which enables aft dome 206 to be indexed to a mandrel. In some examples, closure ring 216 may include at least one shim ply deposited on and extending from a circumferential surface of closure ring 216. The shim ply may include a fiber reinforced thermoplastic that is adhesively bonded to or mechanically fixed to the metal of closure ring 216. During fabrication of aft dome 216, the fiber reinforced thermoplastic of the shim ply may be configured to consolidate with the fiber reinforced thermoplastic of the aft dome.

Forward dome 208 includes a cylindrical portion and a hemispherical portion. The cylindrical portion defines a cavity configured to receive therein at least a portion of the insulator 204. The hemispherical portion defines a curved surface, which may terminate in or otherwise define an aperture within a plane that is normal to a longitudinal axis of rocket motor 200. In some examples, the hemispherical portion is coupled to a polar boss 218 which defines the aperture. Polar boss 218 may be configured to receive therethrough a tooling fixture during assembly of rocket 200, which enables forward dome 208 to be indexed to a mandrel.

Aft dome 206 and forward dome 208 may include the same fiber reinforce thermoplastic as composite case 202 and may be formed using the same or substantially similar techniques as composite case 202. In some examples, at least one of aft dome 206 and forward dome 208 may include an insulator that is the same as or substantially similar to insulator 204 described above.

Attachment features 210 are configured to interface components external to rocket motor 200, such as, for example, lugs configured to couple with a transport or launch vehicle, raceways configured to coupled with fins or strakes, or the like. The number and size of attachment features 210 may be selected to prevent damage to rocket motor 200 during storage, transport, or operation of rocket motor 200. In some examples, attachment features 210 include a nut plate 224 and an interface 226. Nut plate 224 may be disposed under or within at least a portion composite case 202 and define a textured surface that is configured to physically and adhesively bond to composite case 202. Nut plate 224 may be sized and shaped to transfer force to an area of composite cases 202 that is sufficiently large to prevent nut plate 224 from cracking or otherwise damaging a portion of composite case 202 or insulator 204 during storage, transport, or operation of rocket motor 200. Interface 226 may be coupled to nut plate 224 using a suitable fastener. Interface 226 may define any suitable rocket-vehicle interface as known in the art.

Attachment features 210 include a metal, such as an iron alloy, a high strength steel, AF9628 steel, Eglin steel, HP-9-4-20 steel, aluminum alloys, tungsten alloys, titanium alloys, and magnesium alloys. In some examples, attachment features 210 may be formed by conventional methods of casting, forging, subtractive manufacturing, or combinations thereof. In other examples, to reduce manufacturing cost and time, attachment features 210 may be formed using additive manufacturing techniques such as, for example, directed energy deposition, direct metal laser sintering, or powder bed fusion. Some additive manufacturing techniques also include one or more post processing steps such as, for example, hot isostatic pressure heat treatment and shot peening.

Other components positioned between insulator 204 and composite case 202 or embedded in the composite case 202 may include wires, electrical traces, or sensors to enable controls or communications, and flight termination devices such as shaped charges as described in for example commonly assigned U.S. Pat. No. 10,781,773, entitled “Solid Rocket Motors Including Flight Termination Systems, and Related Multi-Stage Solid Rocket Motor Assemblies and Methods,” filed Nov. 4, 2011, the entire contents of this is incorporated herein by reference.

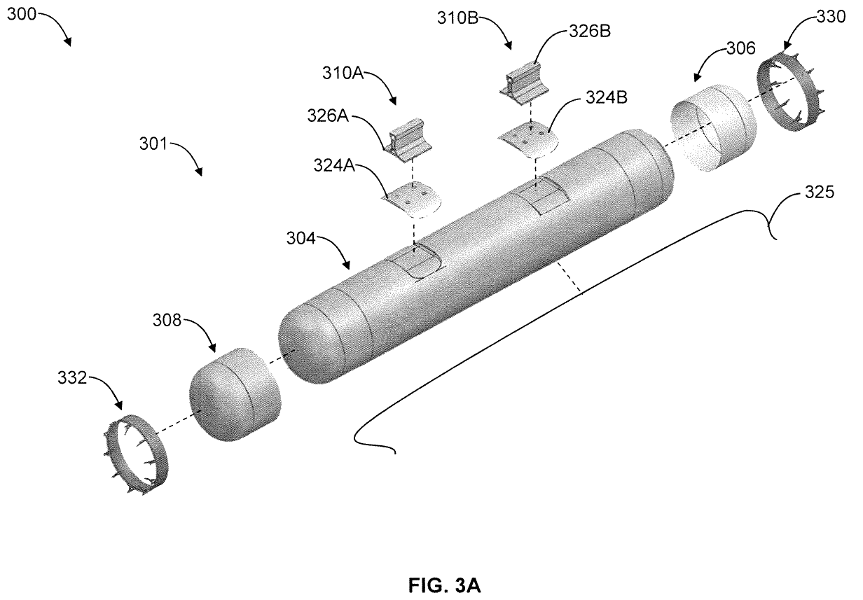

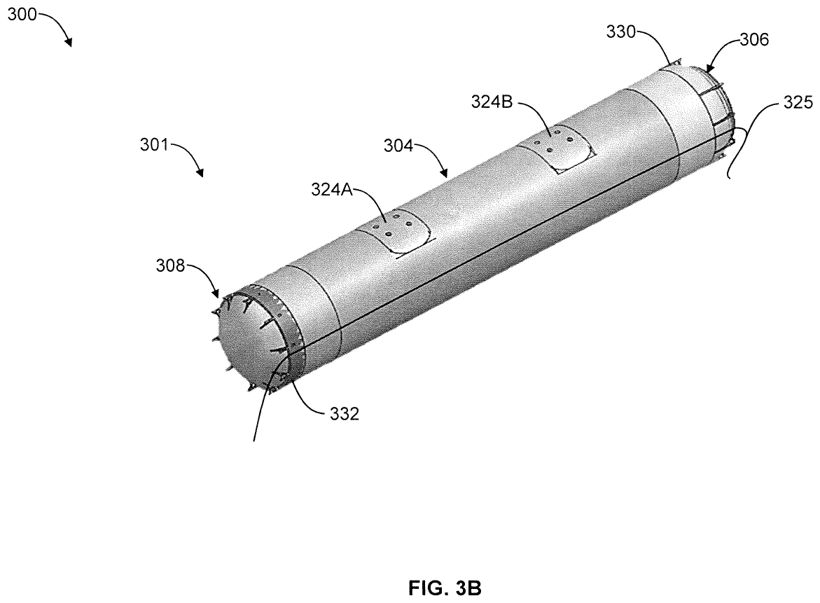

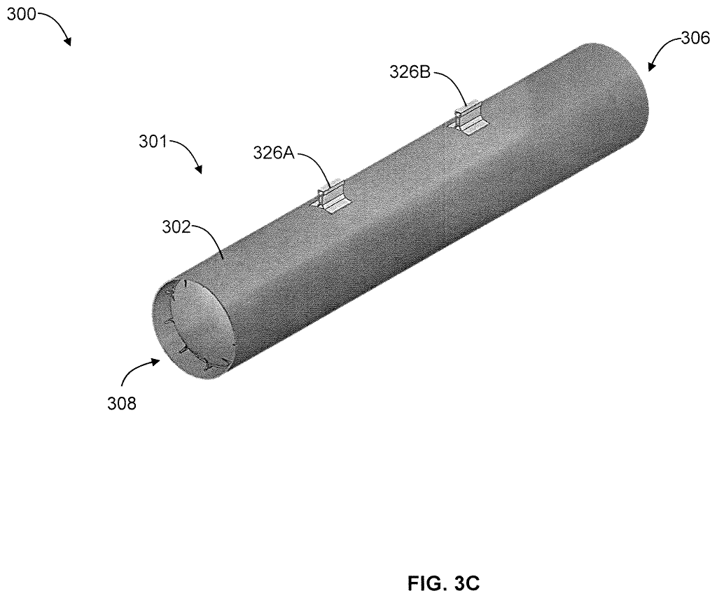

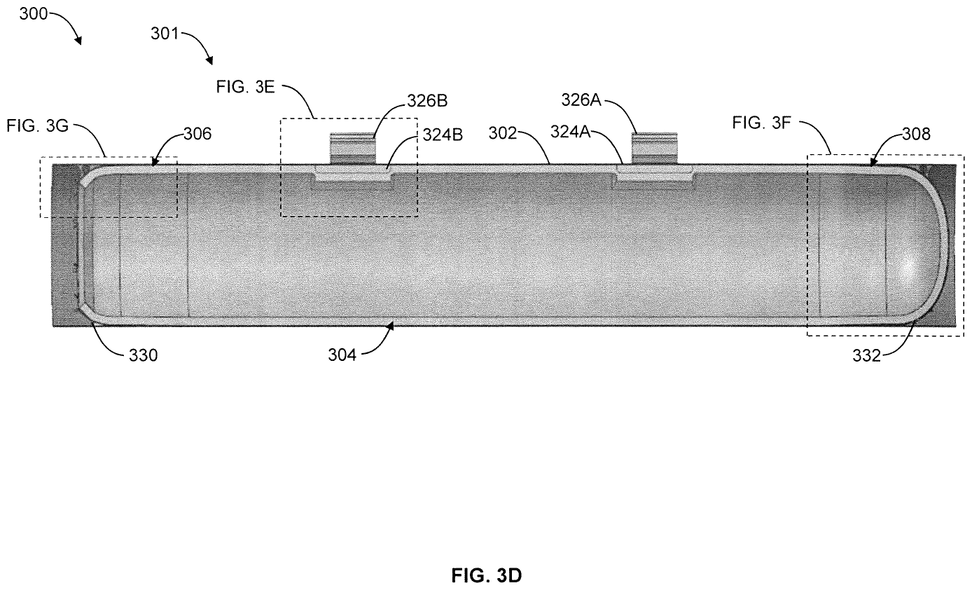

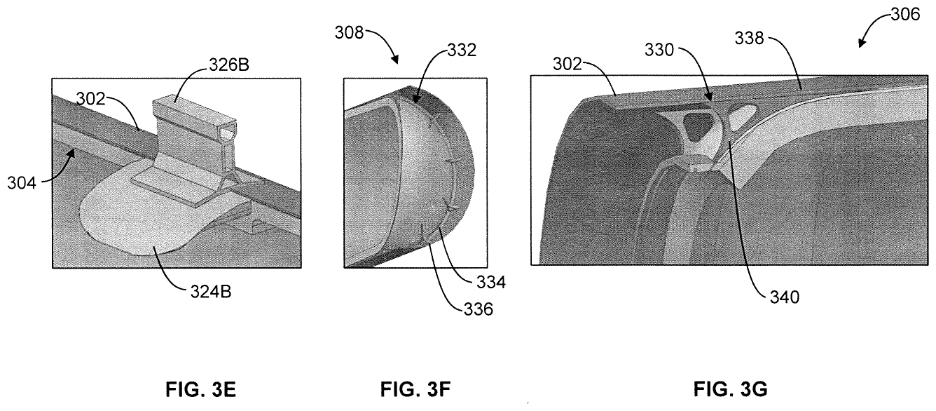

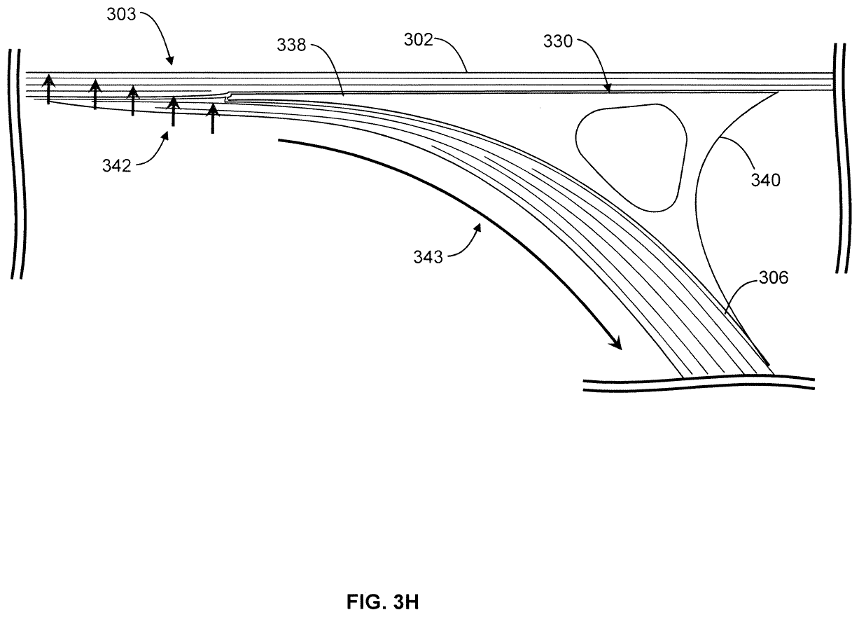

FIGS. 3A through 3I are conceptual diagrams illustrating example component parts of a rocket motor 300. Rocket motor 300 may be the same as or substantially similar to rocket motor 200 described above in reference to FIG. 2, except for the differences described herein. For example, rocket motor 300 includes a composite case 302, an insulator 304, an aft dome 306, a forward dome 308, aft bracket 330, forward bracket 332, and attachment features 310A and 310B (collectively, attachment features 310) which include respective nut plates 324A and 324B (collectively, nut plates 324) and respective interfaces 326A and 326B (collectively, interfaces 326).

The partially exploded view illustrated in FIG. 3A is indicative of the assembly of component parts of rocket 300 prior to fabrication of composite case 302. After fabrication of . each insulator 304, aft dome 306, forward dome 308, nut plates 324, aft bracket 330, and forward bracket 332, which is discussed in further detail below, the components may be assembled to define an assembly 301. For example, aft dome 306 and forward dome 308 are positioned to receive at least a portion of the respective proximal end and distal end of insulator 304. Also, aft bracket 330 and forward bracket 332 are positioned on aft dome 306 and forward dome 308, respectively. Additionally, nut plates 324 and other optional components, such as electrical trace 325, are positioned at selection regions of insulator 304. Although described as including insulator 304, in other examples, one or more of aft dome 306, forward dome 308, nut plates 324, aft bracket 330, forward bracket 332, and electrical trace 325 may be assembled on a cartridge of propellant, e.g., a solid propellant log to define the assembly.

FIG. 3B is a front perspective view of rocket motor 300 after assembly of insulator 304, aft dome 306, forward dome 308, nut plates 324, aft bracket 330, and forward bracket 332, prior to fabrication of composite case 302. As discussed in further detail below, tooling may be fixed to aft dome 304 and forward dome 306 to allow the assembly components to be coupled with an apparatus for fabrication of composite case 302. Additionally, or alternatively, brackets 330 and 332 may serve as noodles configured to support and keep straight, or otherwise assist in the definition of, respective joints at aft dome 306 and forward dome 308 during formation of composite case 302.

FIGS. 3C and 3D are a front perspective view and cross-sectional view, respectively, of rocket motor 300 after fabrication of composite case 302 and coupling of interfaces 326 to respective nut plates 324. Composite case 302 may fully surround each of insulator 304, aft dome 306, forward dome 308, nut plates 324, aft bracket 330, and forward bracket 332. As discussed above, the fiber reinforced thermoplastic of composite case 302 is consolidated with the fiber reinforce thermoplastic of aft dome 306 and forward dome 308 to form a unitary thermoplastic matrix at the interface of composite case 302 and each of aft dome 306 and forward dome 308.

In some examples, to further reinforce the interface composite case 302 with aft dome 306, forward dome 308, or both, reinforcing z-pins may be inserted through one or more layers of composite case 302, aft dome 306, and forward dome 308. Example systems and techniques for using reinforcing z-pins with fabricating thermoplastic composite parts is described in commonly assigned U.S. Pat. No. 11,701,816, entitled “Process for Reinforcing Continuous Fiber Additively Manufactured Laminates,” filed Dec. 15, 2020, the entire contents of which is incorporated by reference herein.

FIGS. 3E, 3F, and 3G illustrate enlarged perspective views of portion of the cross-sectional view of rocket motor 300, as indicated in FIG. 3D.

As illustrated in FIG. 3E, at least a portion of insulator 304 defines a recess in which nut plate 324B is positioned. Recessing nut plate 324B in insulator 304 allows composite case 302 to be substantially planar at the transition from insulator 304 to nut plate 324B. The substantially planar transition may improve the structural integrity of composite case 302 at the interface compared to examples in which nut plate 324B is positioned on a surface of insulator 304 thereby defining a step that composite case 302 would otherwise traverse when deposited. In some examples, to provide further structural integrity of composite case 302 at nut plate 324B (or other fully or partially embedded features), composite case 302 may include additional layers of material.

As illustrated in FIG. 3F, forward bracket 332 includes a ring 334 having a diameter congruent with a diameter of forward dome 308 and a plurality of braces 336 extending radially inward from ring 334. The radially inward surface of each of braces 336 defines a curve congruent with a curvature of the top of forward dome 308. Similarly, as illustrated in FIG. 3G, aft bracket 330 includes a ring 338 having a diameter congruent with a diameter of aft dome 306 and a plurality of braces 340 extending radially inward from ring 338. The radially inward surface of each of braces 340 defines a curve congruent with a curvature of the top of aft dome 306.

Aft bracket 330 and forward bracket 332 may include one or more materials selected to provide additional structural integrity to the respective domes and/or the case-dome interface, such as, for example, steel, PEEK, or other structural materials described herein. The additional support provided by aft bracket 330 and forward bracket 332 when the internal pressure of rocket motor 300 increases during operation may improve prediction of failure point location when rocket motor 300 experience over pressurization. For example, as illustrated in FIG. 3H, an internal pressure exerting an outward force on composite case 302 as indicated by arrows 342 is transferred by bracket 330 and the unitary interface 303 of composite case 302 and aft dome 306 to a lateral pressure load as indicated by arrow 343 through aft dome 306. In some examples, unitary interface 303 does not include a bond line, which may improve the structural integrity of composite case 302 and aft dome 306 under an internal pressure load.

In some examples, nut plates 324, aft bracket 330, and forward bracket 332 may define a textured surface that is configured to physically and adhesively bond to at least the thermoplastic matrix of composite case 302. In some examples, a bond coat may be applied to the surface of nut plates 324, aft bracket 330, and forward bracket 332 to facilitate adhesion with composite case 302. The bond coat may include, for example, a polymeric phosphate ester. In some examples, the textured surface may be treated by degreasing, abrasion, or chemical etching to promote adhesion of the thermoplastic matrix of composite case 302 and/or a bond coat.

Additionally, nut plates 324, aft bracket 330, and forward bracket 332 may be bonded in place, e.g., with a structural epoxy or other adhesive, prior to overlay of composite case 302.

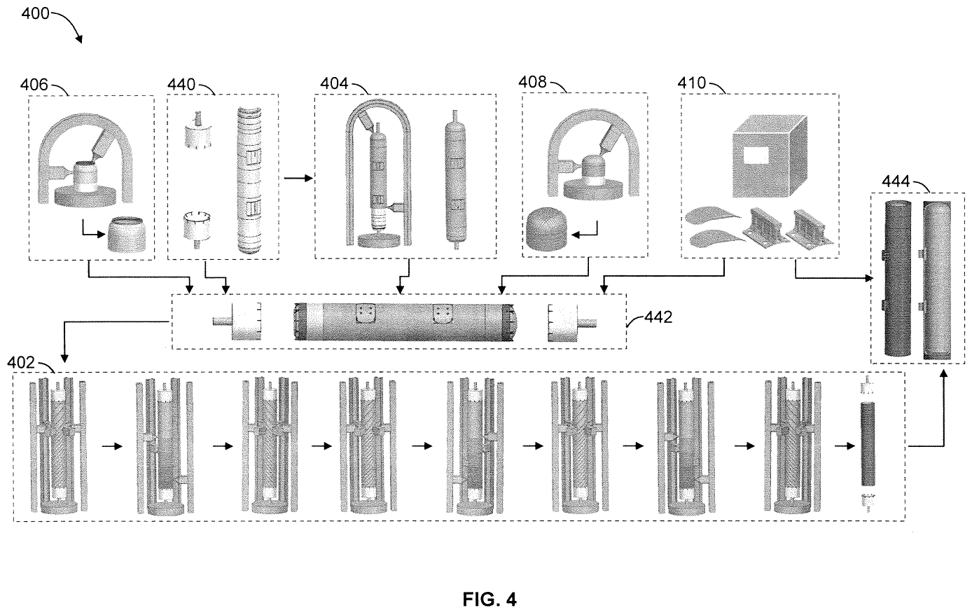

FIG. 4 is a conceptual diagram illustrating an example system 400 for fabricating rocket motors as described herein. System 400 enables parallel fabrication of rocket motor components using continuous fiber additive manufacturing processes and progressive assembly of the rocket motor components to produce a rocket motor assembly having a unitary case and domes. The distinct component fabrication stations and assembly stations of system 400 allow fabrication of durable rocket motors at a high-rate and low-cost compared to other fabrication methods.

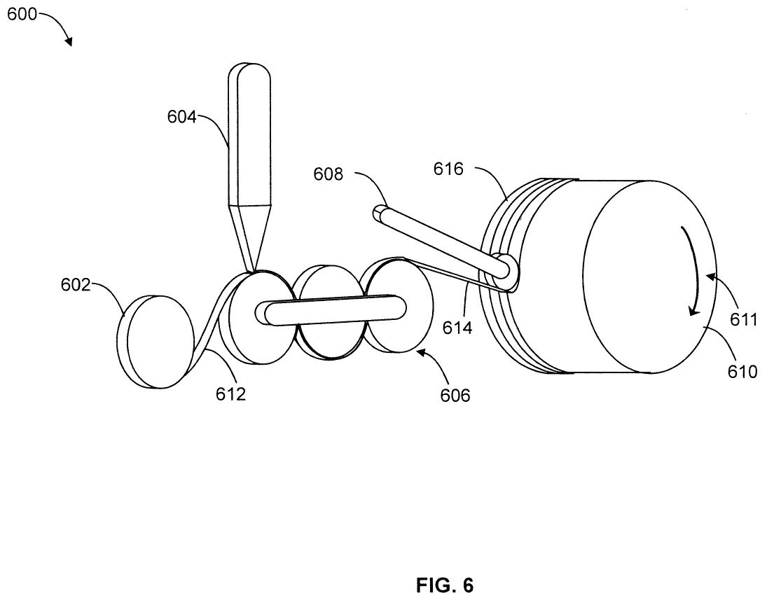

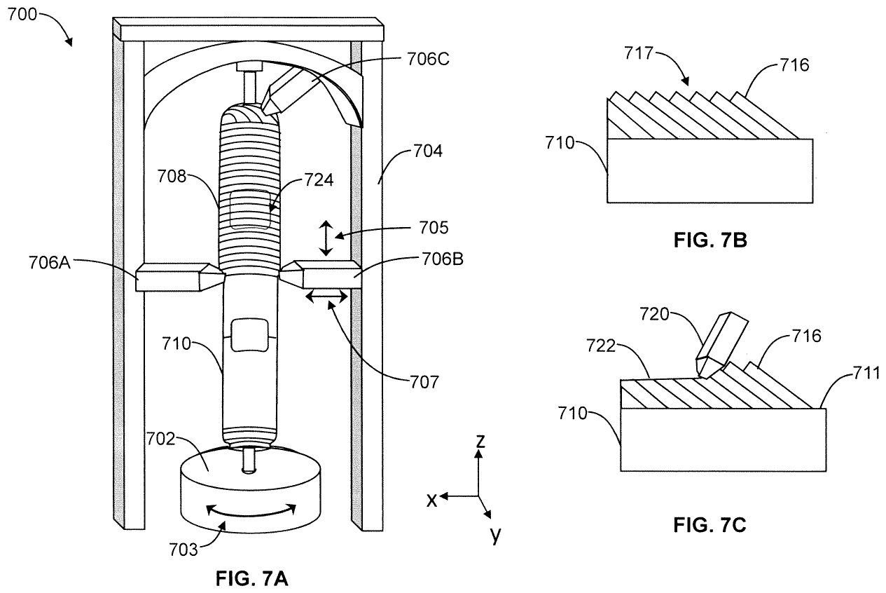

System 400 includes a plurality of stations configured to fabricate one or more selected components of a rocket motor. For example, system 400 may include a composite case station 402, an insulator station 404, an aft dome station 406, a forward dome station 408, an attachment feature station 410, a mandrel assembly station 440, a component assembly station 442, and a final processing station 444. Composite case station 402, an insulator station 404, an aft dome station 406, a forward dome station 408 are described in further detail below in reference to FIGS. 7A through 10D. Attachment feature station 410 may include a three-dimensional printer, such as a powder bed fusion additive manufacturing device, which is configured to fabricate metal components. Mandrel assembly station 440 may include semi-autonomous or autonomous assembly of components, for example, using an assembly robot. Component assembly station 442 may include semi-autonomous or autonomous assembly of components, for example, using an assembly robot. Final processing station 444 may be semi-autonomous or autonomous final machining, assembly, cleaning, and/or quality control checking of the final rocket motor.

In some examples, system 400 may include additional stations, such as stations configured to fabricate and/or assembly of additional components of rocket motor 401, such as wiring, electrical traces, or the like. Also, one station may be configured to perform the fabrication of multiple components. For example, a single station may be configured to fabricate both aft domes and forward domes. Each station of system 400 may include an automated robot that is configured to perform one or more fabrication techniques, such as, for example, deposition of a material, removal of material by machining or the like, or manipulation of a component for assembly or the like.

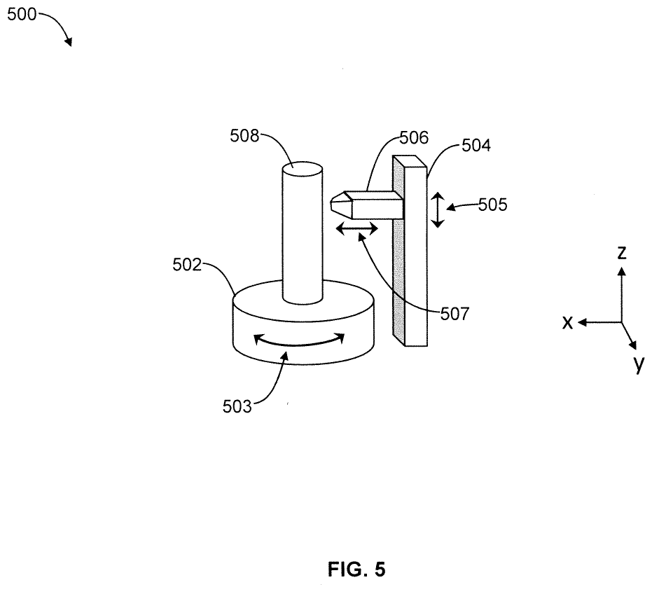

FIG. 5 is a conceptual diagram illustrating an example automated robot 500. Robot 500 includes a platform 502, a frame 504, and a material deposition device 506. Platform 502 may be coupled to a motor that is fixed to a base and configured to rotate platform 502 in the x-y plane as indicated by arrow 503. Platform 502 may receive and secure a tool, such as a portion of a mandrel 508. Frame 504 extends from the base and is coupled to material deposition device 506. Material deposition device 506 is configured to translate in the z-direction as indicated by arrow 505 along a length of frame 504. In some examples, material deposition device 506 may translate in the x-direction (or y-direction) as indicated by arrow 507. By enabling rotation in the x-y plane, translation in the z-direction, and translation in the x-direction, robot 500 is able to control the position of material deposition device 506 with three-degrees of freedom. In other examples, robot 500 may be configured to control material deposition device 506 with additional degrees of freedom, such as, four-, five-, six-, or seven-degrees of freedom, by allowing rotation of material deposition device 506 relative to frame 504 or the like as known in the art.

Material deposition device 506 is configured to deposit material onto a tool or workpiece. In some examples, material deposition device 506 may include a tape winding device having a tape dispenser, a tensioner, a tension sensor, a heating device, and a consolidation roller. The tape dispenser may dispense a thermoplastic prepregnated tape. The tape may be fed through a tensioner, such as a magnetic powder brake, and a tension sensor, which are configured to monitor and adjust the tension of the tape. An optional partial adjust mechanism may be used to monitor and adjust the trajectory of the tape prior to contacting the consolidation roller. The consolidation roller (also referred to as a compaction roller) is configured to apply pressure to the tape as it contacts workpiece 508 to promote forming a unitary thermoplastic matrix and squeeze out air bubbles from the interlaminar contact interfaces to reduce void content. In some examples, the pressure applied by the consolidation roller to the tape and workpiece 508 may be controlled by a pneumatic cylinder or electric actuator. Although illustrated as including one material deposition device 506, in other examples, robot 504 may include at least two opposing material deposition devices (e.g., heads) that are arranged and controlled or otherwise configured to apply an equally opposing force moment on work piece 508. The equally opposing force moment on work piece 508 may reduce or minimize the fixation requirements of work piece 508 to platform 502 and enable increased processing speed, reduced wear on components, improved deposition consistency, or the like relative to configurations that do not provide equally opposing force moment on work piece 508. The heating device is configured to heat the tape and/or workpiece 508 to at least reduce the viscosity of the thermoplastic and improve interlaminar contact degree, or at least partially melt the thermoplastic at the interlaminar contact interface. In some examples, the heating device may include a resistive heater collocated with the consolidation roller. In other examples, the heating device may include a directed energy device, such as a laser or electron beam. Tape winding devices are known in the art and are not further discussed herein.

FIG. 6 is a conceptual diagram illustrating an example material deposition device 600. Device 600 is configured to dispense a prepreg tape including insulator materials as described above to form an insulator, such as insulator 204. In some examples, device 600 includes a tape dispenser 602, an extruder 604, an inline calendar 606, a consolidation roller 608, and a mandrel 610.

Tape dispenser 602 may dispense a tape 612 including at least one of acrylamide fibers, aramid fibers, basalt fibers, carbon fibers, silica fibers, glass fibers, Kevlar®, polybenzamide fibers, polybenzimidazole fibers, or polybenzoxazole fibers. Tape 612 may include a felt tape or fiber tows. The tape may be fed through a tensioner, such as a magnetic powder brake, and a tension sensor, which are configured to monitor and adjust the tension of the tape.

Extruder 604 is configured to extrude a polymeric material onto tape 612. In some examples, the polymeric material may include EPDM or other thermoset polymer. In other examples, the polymeric material may include a thermoplastic.

Inline calendar 606 is configured to incorporate the polymeric material into tape 612 to produce a polymer impregnated tape 614. In some examples, calendar 606 may control a ratio of polymeric material to tape material by, for example, controlling a thickness of polymer impregnated tape 614.

Consolidation roller 608 is configured to apply pressure to polymer impregnated tape 614 as it contacts mandrel 610 and/or previously placed layers 616 to promote adhesion of polymer impregnated tape 614 to previously placed layer 616 and squeeze out air bubbles from the interlaminar contact interfaces to reduce void content. In some examples, the pressure applied by consolidation roller 608 to polymer impregnated tape 614 may be controlled by a pneumatic cylinder or electric actuator.

Mandrel 610 is configured to rotate in a direction indicated by arrow 611 and receive the polymer impregnated tape 614. Mandrel 610 may be treated with a releasing agent to facilitate removal of mandrel 610 from the workpiece after curing or consolidating of polymer impregnated tape 614. In some examples, mandrel 610 may be a formed by additive manufacturing technique such as three-dimensional printing or may include an at least partially inflatable volume such that after forming the workpiece the mandrel may be deflated to facilitate removal of mandrel 610 from the workpiece.

FIGS. 7A through 7C are conceptual diagrams illustrating an example insulator station 700 configured to fabricate an insulator as described herein. Insulator station 700 includes a platform 702, a frame 704, and material deposition devices 706A, 706B, and 706C (collectively, devices 706). In some examples, at least two of devices 706, e.g., material deposition devices 706A and 706B, may be configured to apply the pressure for consolidation with an equally opposing force moment on mandrel 710. The equally opposing force moment on mandrel 710 may reduce or minimize the fixation requirements of mandrel 710 to platform 702 and/or frame 704 to enable increased processing speed, reduced wear on components, improved deposition consistency, or the like relative to configurations that do not provide equally opposing force moment on mandrel 710.

Platform 702 may be coupled to a motor that is fixed to a base and configured to rotate platform 702 in the x-y plane as indicated by arrow 703. Platform 702 may receive and secure a portion of a mandrel 710. Frame 704 extends from the base and is coupled to devices 706.

Devices 706 may be the same as or substantially similar to deposition device 506 or device 600 described above with respect to FIGS. 5 and 6. For example, device 706 may be configured to deposit a polymer impregnated tape, such as an EDPM impregnated tape, onto workpiece 708 and mandrel 710. Devices 706 may translate in at least two directions, e.g., the x-direction (or y-direction) as indicated by arrow 707 and the z-direction as indicated by arrow 705. In some examples, devices 706, such as device 706C, may translate in along an arcuate portion of frame 704. By enabling rotation in the x-y plane, translation in two directions, the position of devices 706 relative to mandrel 710 may be controlled with three-degrees of freedom. Compared to devices having a greater number of degrees of freedom, devices 706 are able to deposit tapes having a greater width, e.g., up to 2-inches or more, while minimizing wrinkles or other imperfections.

In some examples, at least one of device 706 may be configured to deposit a scrim layer. The scrim layer may include additional EDPM material. The scrim layer may be deposited on the mandrel, in between plies of EDPM impregnated tape, or both during a felting/needle stich process.

As illustrated in the conceptual cross-sectional view of FIG. 7B, after deposition, the polymer impregnated tape 716 may define a shingle ply. That is, an exterior surface 717 may define a plurality of ridges and a plurality of valleys. In some examples, a surface that is more planar than exterior surface 717 may be desirable. For example, a surface that is more planar may reduce voids and/or promote adhesion of additional layers.

As illustrated in the conceptual cross-sectional view of FIG. 7C, post deposition processing of workpiece 708 may include machining exterior surface 717 to at least partially remove the plurality of ridges. Machining may include, for example, using a bit 720 to lathe at least a portion of the plurality of ridges to provide a more planar surface 722. In some examples, planar surface 722 may be substantially parallel to a surface 711 of mandrel 710. Although described as using a lathing process, one or more different substrative manufacturing technique may be used to remove material from exterior surface 717, such as, for example, routing, drilling, grinding, lasing, or the like. Any of the above subtractive manufacturing techniques may be controlled by computer numerical control (CNC).

In some examples, additional polymer impregnated tape 716 may be removed in first regions relative to second regions. For example, a first region 724 (FIG. 7A) may be machined more than adjacent second regions to define a recess configured to receive therein a nut plate (e.g., nut plates 324). Such post processing steps may be used to provide a workpiece 708 that is configured to receive additional components during assembly.

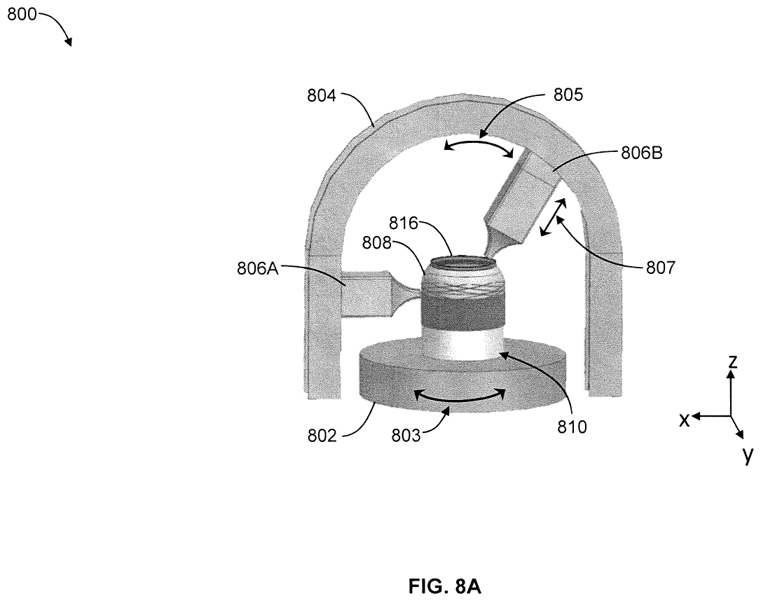

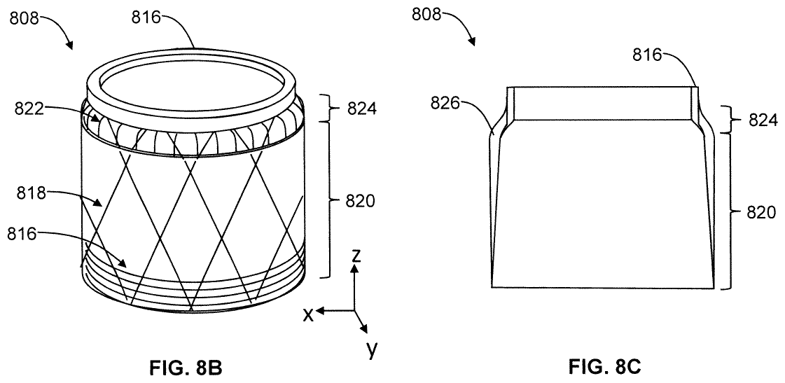

FIGS. 8A through 8C are conceptual diagrams illustrating an example aft dome station 800. Aft dome station 800 includes a platform 802, a frame 804, and material deposition devices 806A and 806B (collectively, devices 806). Aft dome station 800 is configured to fabricate a workpiece 808, which may include an aft dome that is the same as or substantially similar to aft dome 306 described above in reference to FIGS. 3A through 3H.

Platform 802 may be coupled to a motor that is fixed to a base and configured to rotate platform 802 in the x-y plane as indicated by arrow 803. Platform 802 may receive and secure a portion of a mandrel 810. Mandrel 810 may be configured to receive thereon a closure ring 816 which, in some examples, may be removably fixed to a tooling extending from a portion of frame 804 to support workpiece 808 during a winding process. Frame 804 extends from the base and is coupled to devices 806.

Devices 806 may be the same as or substantially similar to deposition device 506 or device 600 described above in reference to FIGS. 5 and 6. For example, device 806 may be configured to deposit tapes including a fiber reinforced thermoplastic onto workpiece 808 and/or mandrel 810. Devices 806 may translate in at least two directions. In one example, device 806B may be configured to translate in a direction perpendicular to frame 804 as indicated by arrow 807 and translate in a plane defined by frame 804, e.g., the x-z plane, including about at least a portion of an arcuate portion of frame 804 as indicated by arrow 805. Such translations may be selected to provide for control of the position of devices 806 relative to workpiece 808 and/or mandrel 810 with three-degrees of freedom which, as discussed above, may enable devices 806 to deposit tapes having a greater width while minimizing wrinkles or other imperfections.

In some examples, devices 806 may be configured to deposit tapes having different widths, e.g., up to 2-inches or more. A suitable tape width may be selected based on a type of winding (e.g., hoop, helical, or polar) and a curvature of the surface on which the tape is deposited (e.g., degree of curvature and number of planes in which the curve lies such as a single-curve or a double-curve). For example, device 806A may be configured to deposit tapes in a hoop winding 816 or a helical winding 818 on a cylindrical portion 820 of workpiece 808, whereas device 806B may be configured to deposit tapes in a helical winding 818 or a polar winding 822 on a hemispherical portion 824 of workpiece 808. Because a curvature of hemispherical portion 824 may be greater than a curvature of cylindrical portion 820, device 806B may use a narrower tape compared to device 806A to reduce or prevent wrinkles, voids, or other imperfections in the tape. Alternatively, because hemispherical portion 824 includes a double-curve (i.e., a first curve in the x-y plane and a second curve in the z-direction) device 806B may used a narrower tape to reduce or prevent wrinkles or other imperfections in the tape compared to device 806A which deposits tape on the single curve of cylindrical portion 820.

As illustrated in the conceptual cross-sectional view of FIG. 8C, sidewall 826 of workpiece 808 may be tapered from a thicker region of hemispherical portion 824 adjacent to closure ring 816 to a thinner region of cylindrical portion 824. The taper of sidewall 826 may be configured to better secure closure ring 816 to workpiece 808, improve a structural integrity of hemispherical portion 824, or both.

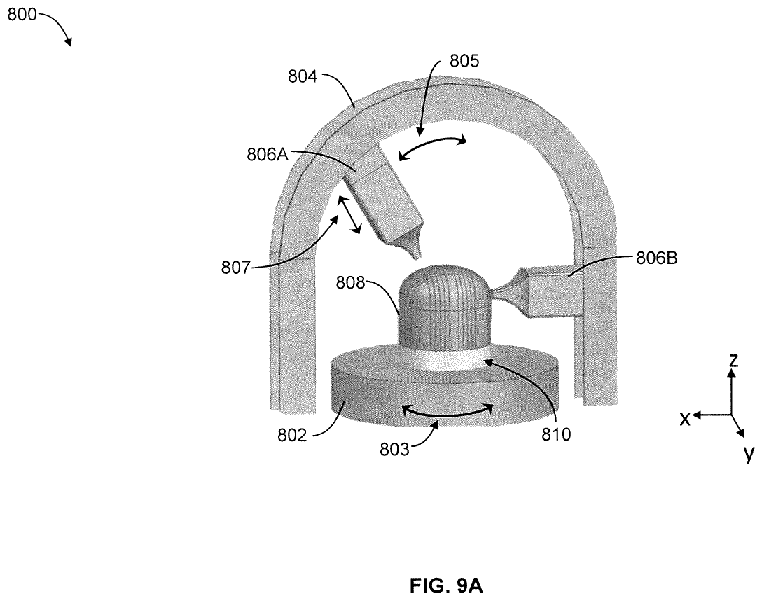

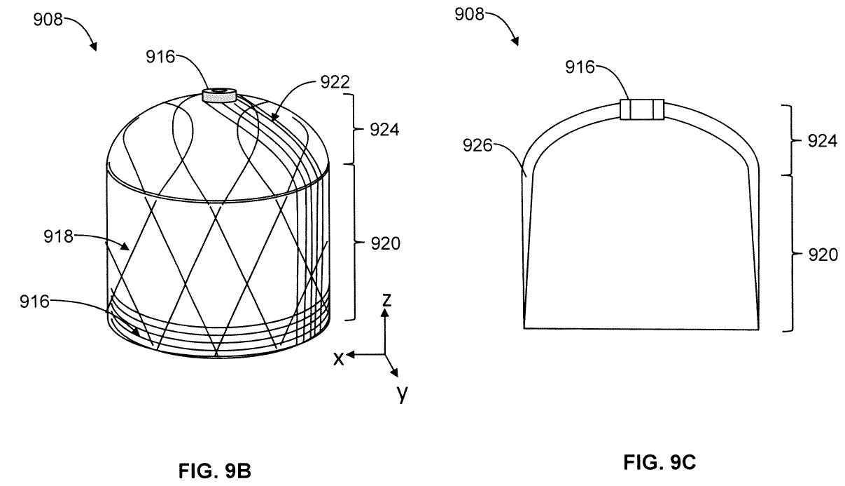

FIGS. 9A through 9C are conceptual diagrams illustrating an example forward dome station 900. Forward dome station 900 includes a platform 902, a frame 904, and material deposition devices 906A and 906B (collectively, devices 906). Forward dome station 900 is configured to fabricate a workpiece 908, which may include a forward dome that is the same as or substantially similar to forward dome 308 described above in reference to FIGS. 3A through 3H.

Platform 902 may be coupled to a motor that is fixed to a base and configured to rotate platform 902 in the x-y plane as indicated by arrow 903. Platform 902 may receive and secure a portion of a mandrel 910. Mandrel 910 may be configured to receive thereon a polar boss 916 which, in some examples, may be removably fixed to a tooling extending from a portion of frame 904 to support workpiece 908 during a winding process. Frame 904 extends from the base and is coupled to devices 906.

Devices 906 may be the same as or substantially similar to devices 806 described above in reference to FIG. 8A. For example, device 906 may be configured to deposit tapes including a fiber reinforced thermoplastic onto workpiece 908 and/or mandrel 910. Devices 906 may translate in at least two directions. In one example, device 906B may be configured to translate in a direction perpendicular to frame 904 as indicated by arrow 907 and translate in a plane defined by frame 904, e.g., the x-z plane, including about at least a portion of an arcuate portion of frame 904 as indicated by arrow 905. Such translations may be selected to provide for control of the position of devices 906 relative to workpiece 908 and/or mandrel 910 with three-degrees of freedom which, as discussed above, may enable devices 906 to deposit tapes having a greater width while minimizing wrinkles or other imperfections.

In some examples, devices 906 may be configured to deposit tapes having different widths, e.g., up to 2-inches or more. A suitable tape width may be selected based on a type of winding (e.g., hoop, helical, or polar) and a curvature of the surface on which the tape is deposited (e.g., degree of curvature and number of planes in which the curve lies such as a single-curve or a double-curve). For example, device 906A may be configured to deposit tapes in a hoop winding 916 or a helical winding 918 on a cylindrical portion 920 of workpiece 908, whereas device 906B may be configured to deposit tapes in a helical winding 918 or a polar winding 922 on a hemispherical portion 924 of workpiece 908. Because a curvature of hemispherical portion 924 may be greater than a curvature of cylindrical portion 920, device 806B may use a narrower tape compared to device 906A to reduce or prevent wrinkles, voids, or other imperfections in the tape. Alternatively, because hemispherical portion 924 includes a double-curve (i.e., a first curve in the x-y plane and a second curve in the z-direction) device 906B may use a narrower tape to reduce or prevent wrinkles or other imperfections in the tape compared to device 906A which deposits tape on the single curve of cylindrical portion 920.

As illustrated in the conceptual cross-sectional view of FIG. 9C, sidewall 926 of workpiece 908 may be tapered from a thicker region of hemispherical portion 922 adjacent to polar boss 916 to a thinner region of cylindrical portion 922. The taper of sidewall 926 may be configured to better secure polar boss 916 to workpiece 908, improve a structural integrity of hemispherical portion 922, or both.

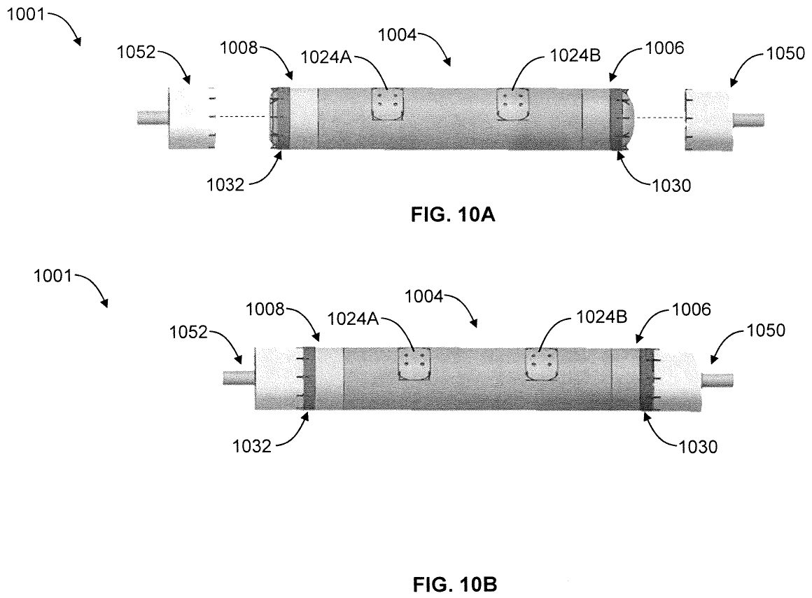

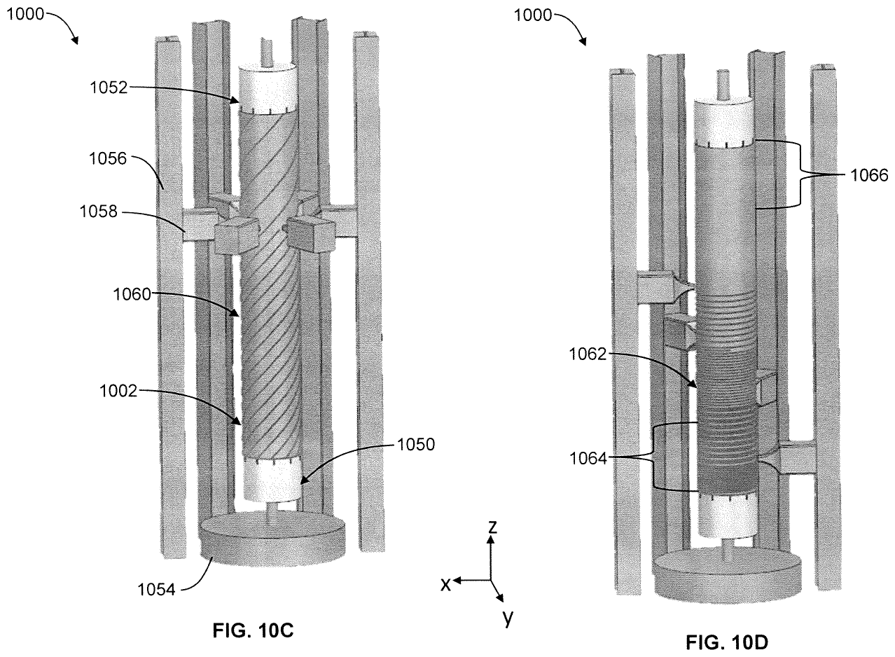

FIGS. 10A through 10D are conceptual diagrams illustrating an example composite case station 1000. Composite case station 1000 is configured to deposit on an assembly of rocket motor components 1001 (hereinafter, assembly 1001) a fiber reinforced thermoplastic to define a unitary case and end domes. In some examples, composite case station 1000 also may be configured to perform assembly of prefabricated rocket motor components, prepare assembly 1001 for fabrication of the case, or both.

As illustrated in FIGS. 10A and 10B, assembly 1001 includes aft dome 1006 and forward dome 1008 that are positioned to receive at least a portion of the respective proximal and distal ends of insulator 1004. Prior to or after positioning the end domes, aft bracket 1030 and forward bracket 1032 are positioned on aft dome 1006 and forward dome 1008, respectively. Optionally, nut plates 1024A and 1024B (collectively, nut plates 1024) are positioned at selection regions of insulator 1004.

After assembly of insulator 1004, aft dome 1006, forward dome 1008, aft bracket 1030, forward bracket 1032, and nut plates 1024, fixtures 1050 and 1052 may be removably coupled to aft dome 1004 and forward dome 1006, respectively. Fixtures 1050 and 1052 include respective tooling that index with portions of the respective aft dome 1004 and forward dome 1006 to enable assembly 1001 to be operatively coupled to and located in composite case station 1000 for deposition of the fiber reinforced thermoplastic of composite case 1002. For example, aft dome 1006 may include a closure ring (e.g., closure ring 216) which may removably couple to fixture 1050 and allow a proximal portion of assembly 1001 to be indexed or otherwise controllably positioned within composite case station 1000. Similarly, forward dome 1008 may include a polar boss (e.g., polar boss 218) which may be removably coupled to fixture 1052 and allow a distal portion of assembly 1001 to be indexed or otherwise controllably positioned within composite case station 1000. In some examples, fixtures 1050 and 1052 may facilitate handling of assembly 1001 prior to deposition of composite case 1002.

As illustrated in FIGS. 10C and 10D, after preparation, assembly 1001 is positioned in composite case station 1000. Composition case station 1000 may be the same as or substantially similar to aft dome station 800 and forward dome station 900, except for the differences described herein. For example, composite case station 1000 may include a platform 1054 and plurality of frames 1056 (hereinafter, frames 1056) extending from a base, as well as a plurality of material deposition devices 1058 (hereinafter, devices 1058) operatively coupled to a respective frame of frames 1056. Platform 1054 may be configured to retain fixture 1050 and rotate relative to frames 1056. In some examples, composite case station 1000 may include a second platform configured to retain fixture 1052. Each material deposition device of device 1058 may be configured to translate along at least a portion of the respective frame of frames 1056 and be configured to actuate in at least one additional direction (e.g., translate in a direction perpendicular to a respective frame of frames 1056) such that a position of each of devices 1058 relative to assembly 1001 is controllable with at least three-degrees of freedom.

In some examples, devices 1058 may be configured to apply the pressure for consolidation with an equally opposing force moment on assembly 1001. The equally opposing force moment on assembly 1001 may reduce or minimize the fixation requirements of assembly 1001 to platform 1054 to enable increased processing speed, reduced wear on components, improved deposition consistency, or the like relative to configurations that do not provide equally opposing force moment on assembly 1001.

Once positioned, composite case station 1000 may deposit tape, such as a fiber reinforced thermoplastic tape, to assembly 1001. Device 1058 may be configured to deposit tapes in any suitable configuration such as a helical winding 1060, a hoop winding 1062, or another winding pattern to form composite case 1002. Tapes may have any suitable width, such as up to 2-inches or more. During deposition, device 1058 is configured to consolidate the tape with a thermoplastic of aft dome 1006 in a proximal region 1064 and a thermoplastic of forward dome 1008 in a distal region 1066. In this way, composite case station 1000 is configured to form a unitary case and end dome rocket motor.

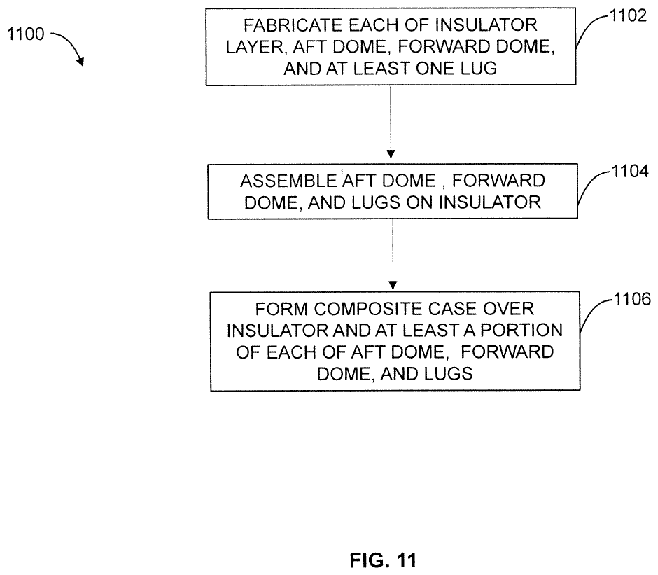

FIG. 11 is a flow diagram illustrating an example technique 1100 of manufacturing a rocket motor. For purposes of illustration, technique 1100 is described in reference to rocket motor 300 described above. However, technique 1100 may be used to manufacture other rocket motors. Additionally, the rocket motors described herein may be manufactured using other techniques.

The technique illustrated in FIG. 11 includes fabricating one or more of insulator 304, aft dome 306, forward dome 308, and at least one attachment feature 310 (1102). Fabricating insulator 304 may include winding onto a mandrel a felt tape including at least one of a carbon fiber, a silica fiber, and an aramid fiber impregnated with ethylene propylene diene terpolymer (EPDM). In some examples, fabricating insulator 304 may include winding onto a mandrel a felt tape forming a shingle ply wrap 716 on the mandrel and machining the shingle ply wrap to at least partially reduce a proud edge of the shingle ply wrap.

In some examples, fabricating attachment feature 310 may include three-dimensional printing of a metal alloy, such as AF9628 bunker buster steel. After fabrication or subsequent surface preparation, such as peening, abrasion, or etching, attachment feature 310 may define a textured surface configured to physically and adhesively bond with composite case 302, which may facilitate transfer of forced applied to attachment feature 310 to composite case 302 without damaging composite case 302.

In some examples, fabricating aft dome 306 and forward dome 308 includes forming, by the additive manufacturing technique, aft dome 306 and forward dome 308 including the same or substantially similar fiber reinforced thermoplastic as composite case 302. For example, the thermoplastic of each of composite case 302, aft dome 306, and forward dome 308 may be configured to consolidate during deposition of composite case 302 to define a unitary thermoplastic matrix at the interfaces with aft dome 306 and forward dome 308.

The technique illustrated in FIG. 11 also includes assembling aft dome 306, forward dome 308, and attachment features 310 on insulator 304 (1104). In some examples, at least one of aft dome 306, forward dome 308, and attachment features 310 may be assembled on a propellant log. After assembling these components, the technique includes forming, by an additive manufacturing technique, composite case 302 over insulator 304 and at least a portion of at least one of aft dome 306, forward dome 308, and attachment features 310 (1106). Composite case 302 includes a fiber reinforced thermoplastic that is configured to define a unitary thermoplastic matrix at the interfaces with aft dome 306 and forward dome 308. The additive manufacturing technique may include at least one directed energy deposition process that provides from in-situ consolidation of the thermoplastic of aft dome 306 and forward dome 308 with respective portion of the fiber reinforced thermoplastic of composite case 302. For example, the additive manufacturing technique may include automated consolidating filament tape winding. In some examples, forming the composite case may include forming, by the additive manufacturing technique, stiffening regions on at least a portion of composite case 302. In some examples, forming composite case 302 may include embedding within composite case 302 at least one of an internal feature, an external feature, and a control wire 325.

Once formed, composite case 302 may be substantially free of bond lines. For example, regions defining the interface between each of fabricated aft dome 306 and forward dome 308 with composite case 320 may include a consolidated and unitary thermoplastic matrix without any thermoset polymer or adhesive materials disposed at or near the interface. By defining a unitary thermoplastic matrix at the interface, when in operation, stress transition regions between at least a portion of composite case and at least one of aft dome 306 and forward dome 308 is internal to the fiber reinforced composite.

In some examples, forming composite case 302 over each of aft dome 306 and forward dome 308 integrates at least one layer of the fiber reinforced thermoplastic of aft dome 306 and forward dome 308 with at least one layer of the fiber reinforce thermoplastic of composite case 302. The technique also may include loading a cartridge of propellant. In some examples, aft dome 306 may be fixed to composite case 302 after loading the cartridge of propellant. For example, after loading the cartridge of propellant, aft dome 306 may be fixed to the formed composite case by ultra sonic welding. Ultra sonic welding may enable formation of a unitary thermoplastic matrix at the interface between aft dome 306 and composite case 302.

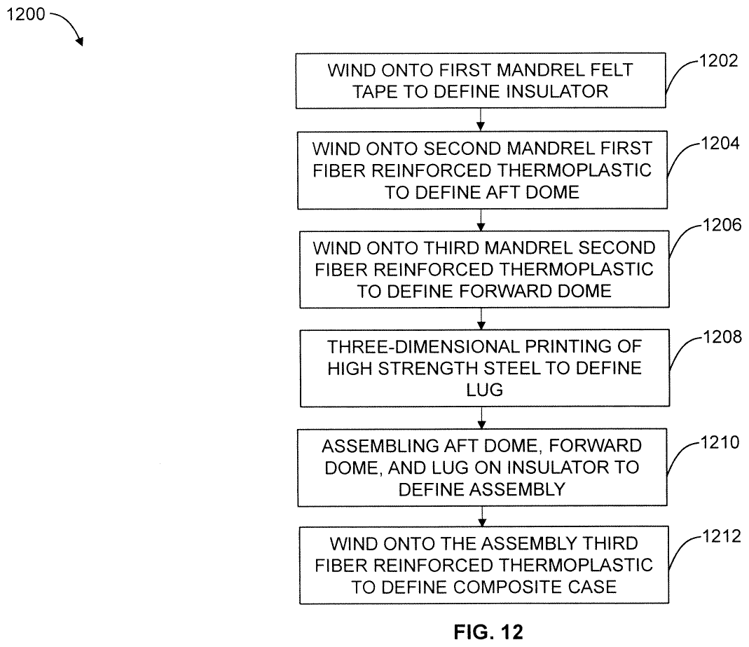

FIG. 12 is a flow diagram illustrating an example technique 1200 of manufacturing a rocket motor. For purposes of illustration, technique 1200 is described in reference to rocket motor 300 described above. However, technique 1200 may be used to manufacture other rocket motors. Additionally, the rocket motors described herein may be manufactured using other techniques.

The technique illustrated in FIG. 12 includes winding onto a first mandrel a felt tape comprising at least one of a carbon fiber, a silica fiber, and an aramid fiber impregnated with an ethylene propylene diene terpolymer (EPDM) to define insulator 304 (1202). In some examples, winding the felt tape to define insulator 304 may include winding onto the first mandrel the felt tape to form a shingle ply that defines a plurality of ridges and a plurality of valleys, curing the EPDM to form a cured shingle ply, and machining the cured shingle ply to remove at least a portion of the plurality of ridges. The machined insulator 304 may define a surface that is better suited for adhesion of overlayers, to reduce porosity when receiving overlayers, or both.

The technique illustrated in FIG. 12 also includes winding onto a second mandrel, a first fiber reinforced thermoplastic to define aft dome 306 (1204) and winding onto a third mandrel a second fiber reinforced thermoplastic to define forward dome 308 (1206).

The technique illustrated in FIG. 12 also includes three-dimensional printing of a high strength steel to define at least one attachment feature 310 (1208). In some examples, three-dimensional printing of the at least one attachment feature 310 may include printing, by powder bed fusion, AF9628 steel to define the at least one attachment feature 310. Additional components may be similarly fabricated by three-dimensional printing, such as, for example, brackets 330 and 332, closure ring 216, and polar boss 218. These metal components may be fabricated or processes (e.g., by peening, abrasion, or etching) to define a textured surface configured to physically and adhesively bond with a thermoplastic of composite case 302.

The technique illustrated in FIG. 12 also includes assembling aft dome 306, forward dome 308, and at least one attachment feature 310 on insulator 304 to define an assembly (1210). Assembly may be completed autonomously, e.g., by an assembly robot, semi-autonomously, or manually. In some examples, assembly may include application of adhesives or tooling to at least temporarily fix components in place. For example, nut plates 324 of attachment features 310, brackets 330 and 332, closure ring 216, polar boss 218, or other components may be temporarily fix to insulator 304, aft dome 306, or forward dome 308 using adhesives or tooling prior to and/or during deposition of composite case 302.

The technique illustrated in FIG. 12 also includes winding onto the assembly, a third fiber reinforced thermoplastic to define a composite case (1212). Winding any of the first, second, or third fiber reinforced thermoplastic may include a automated consolidating filament tape winding process. At least a first portion of the third fiber reinforced thermoplastic is consolidated with at least a portion of the first fiber reinforced thermoplastic to define a first unitary interface between aft dome 306 and composite case 302. Also, at least a second portion of the third fiber reinforced thermoplastic is consolidated with at least a portion of the first fiber reinforced thermoplastic to define a second unitary interface between forward dome 308 and composite case 302. By forming unitary interfaces, stress transition regions between composite case 302 and aft dome 306 at the first unitary interface and forward dome 308 at the second unitary interface may remain internal to the composite structure.

In some examples, winding of the third fiber reinforced thermoplastic may be controlled to form stiffening regions on at least a portion of composite case 302. The technique also may include embedding within composite case 302, such as prior to or during the winding of composite case 302, at least one of an internal feature, an external feature, and a control wire. The technique also may include loading a cartridge of propellant into a cavity defined by insulator 304.

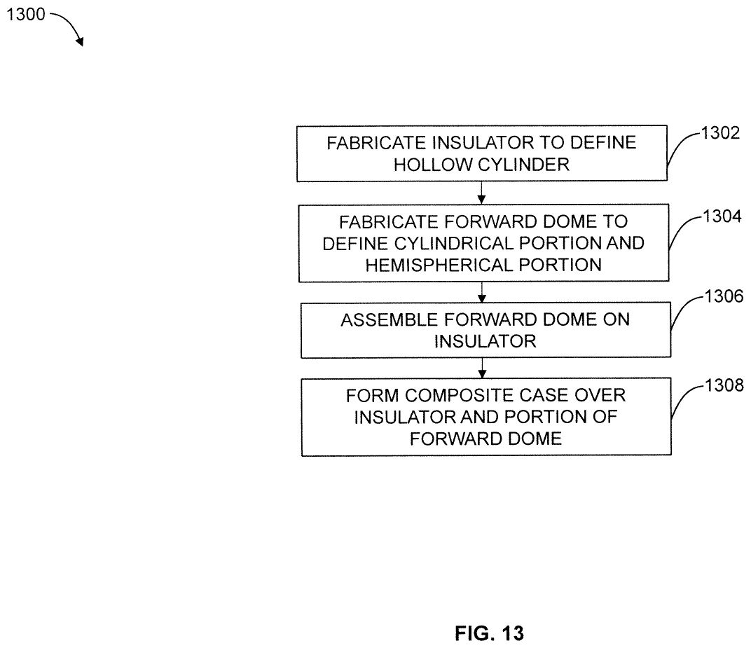

FIG. 13 is a flow diagram illustrating an example technique 1300 of manufacturing a rocket motor. For the purposes of illustration, technique 1300 is described in reference to rocket motor 300 described above. However, technique 1300 may be used to manufacture other rocket motors. Additionally, the rocket motors described herein may be manufactured using other techniques.

The technique illustrated in FIG. 13 includes fabricating insulator 304 to include a wound felt tape having at least one of a carbon fiber, a silica fiber, and an aramid fiber impregnated and ethylene propylene diene terpolymer (EPDM) and define a hollow cylinder extending along longitudinal axis from a proximal end to a distal end (1302). In some examples, fabricating insulator 304 may include winding onto the mandrel the felt tape to form a shingle ply comprising a plurality of ridges and a plurality of valleys, curing the EPDM to form a cured shingle ply, and machining the cured shingle ply to remove at least a portion of the plurality of ridges.

The technique illustrated in FIG. 13 also includes fabricating forward dome 306 including a first fiber reinforced thermoplastic to define a cylindrical portion and a hemispherical portion extending from the cylindrical portion (1304).

The technique illustrated in FIG. 13 also includes assembling forward dome 308 on insulator 304 such that at least a portion of the cylindrical portion of forward dome 308 overlaps at least a portion of the hollow cylinder of insulator 304 (1306). In some examples, the technique may include fabricating at least one attachment feature 310 using AF9628 steel and assembling the attachment feature 310 with the other components.

The technique illustrated in FIG. 13 also includes forming composite case 302 including a second fiber reinforced thermoplastic over the insulator and at least a portion of each of forward dome 308 (1308). At least a portion of the first fiber reinforced thermoplastic of forward dome 308 is consolidated with at least a portion of the second fiber reinforced thermoplastic of composite case 302 to define a unitary interface. For example, forming the composite case may include automated consolidating filament tape winding of the second fiber reinforced thermoplastic over insulator 304 and at least a portion of each of forward dome 308. In some examples, forming composite case 302 may include forming stiffening regions on at least a portion of composite case 302; at least partially embedding within the second fiber reinforced thermoplastic at least one of an internal feature, an external feature, and a control wire; or both.

In some examples, the technique also may include fabricating aft dome 306 including a third fiber reinforced thermoplastic to define a cylindrical portion and a hemispherical portion extending from the cylindrical portion and defining an aperture. When forming composite case 302, the technique may include forming composite case 302 over at least a portion of each of aft dome 306, such that at least a portion of the third fiber reinforced thermoplastic of aft dome 306 is consolidated with at least a portion of the second fiber reinforce thermoplastic of composite case 302 to define a second unitary interface. Alternatively, the technique may include ultra sonic welding of at least a portion of the third fiber reinforced thermoplastic of aft dome 306 to at least a portion of the second fiber reinforce thermoplastic of composite case 302 to define a second unitary interface. Either prior to or after coupling aft dome 306 to composite case 302, the technique may include loading a cartridge of propellant into a cavity defined by the insulator.

The following clauses illustrate example subject matter described herein:
Clause 1. A method of manufacturing a rocket motor, wherein the method comprises: winding onto a first mandrel a first fiber reinforced thermoplastic to define an aft dome; winding onto a second mandrel a second fiber reinforced thermoplastic to define a forward dome; three-dimensional printing of a high strength metal or alloy to define at least one attachment feature; assembling the aft dome, the forward dome, and the at least one attachment feature on a third mandrel to define an assembly; and winding onto the assembly, a third fiber reinforced thermoplastic to define a composite case, wherein at least a first portion of the third fiber reinforced thermoplastic is consolidated with at least a portion of the first fiber reinforced thermoplastic to define a first unitary interface between the aft dome and the composite case, and wherein at least a second portion of the third fiber reinforced thermoplastic is consolidated with at least a portion of the first fiber reinforced thermoplastic to define a second unitary interface between the forward dome and the composite case.
Clause 2. The method of claim 1, wherein winding at least one of the first, second, or third fiber reinforced thermoplastic comprises automated consolidating filament tape winding.
Clause 3. The method of claim 1 or 2, wherein the method further comprises at least one of: forming stiffening regions on at least a portion of the composite case; and embedding within the composite case at least one of an internal feature, an external feature, and a control wire.
Clause 4. The method of any one of claims 1 through 3, wherein the method further comprises winding onto a fourth mandrel a felt tape comprising at least one of a carbon fiber, a silica fiber, and an aramid fiber impregnated with an ethylene propylene diene terpolymer (EPDM) to define an insulator, and wherein assembling comprises assembling the aft dome, the forward dome, and at least one attachment feature on the insulator to define the assembly.
Clause 5. The method of claim 4, wherein the method further comprises, winding onto the fourth mandrel further comprises winding the felt tape to form a shingle ply comprising a plurality of ridges and a plurality of valleys; curing the EPDM to form a cured shingle ply; and machining the cured shingle ply to remove at least a portion of the plurality of ridges.
Clause 6. The method of claim 4 or 5, wherein the method further comprises loading a cartridge of propellant into a cavity defined by the insulator.
Clause 7. The method of any one of claims 1 through 6, wherein stress transition regions between the composite case and the aft dome at the first unitary interface and the forward dome at the second unitary interface is internal to the composite case.
Clause 8. The method of any one of claims 1 through 7, wherein the method further comprises forming the attachment feature to define a textured surface configured to physically and adhesively bond with the third fiber reinforced thermoplastic of the composite case.
Clause 9. The method of any one of claims 1 through 8, wherein three-dimensional printing of the at least one attachment feature comprises printing, by powder bed fusion, AF9628 steel to define the at least one attachment feature.
Clause 10. A method of manufacturing a rocket motor, wherein the method comprises: fabricating a forward dome comprising a first fiber reinforced thermoplastic, wherein the forward dome comprises a cylindrical portion and a hemispherical portion extending from the cylindrical portion; assembling the forward dome on a mandrel; and forming a composite case comprising a second fiber reinforced thermoplastic over at least a portion of each of the forward dome, wherein at least a portion of the first fiber reinforced thermoplastic of the forward dome is consolidated with at least a portion of the second fiber reinforce thermoplastic of the composite case to define a unitary interface.
Clause 11. The method of claim 10, wherein forming the composite case comprises automated consolidating filament tape winding of the second fiber reinforced thermoplastic over the mandrel and at least a portion of each of the forward dome.
Clause 12. The method of claim 10 or 11, wherein forming the composite case further comprises at least one of: forming stiffening regions on at least a portion of the composite case; and at least partially embedding within the second fiber reinforced thermoplastic at least one of an internal feature, an external feature, and a control wire.
Clause 13. The method of any one of claims 10 through 12, wherein the method further comprises fabricating an insulator comprising a wound felt tape comprising at least one of a carbon fiber, a silica fiber, and an aramid fiber impregnated and ethylene propylene diene terpolymer (EPDM), wherein the insulator comprises a hollow cylinder extending along longitudinal axis from a proximal end to a distal end, wherein assembling the forward dome on the mandrel comprises assembling the forward dome on the insulator, and wherein at least a portion of the cylindrical portion of the forward dome overlaps at least a portion of the hollow cylinder of the insulator.
Clause 14. The method of claim 13, wherein fabricating the insulator comprises:
winding onto the mandrel the felt tape to form a shingle ply comprising a plurality of ridges and a plurality of valleys; curing the EPDM to form a cured shingle ply; and machining the cured shingle ply to remove at least a portion of the plurality of ridges.
Clause 15. The method of claim 13 or 14, wherein the method comprises loading a cartridge of propellant into a cavity defined by the insulator.
Clause 16. The method of any one of claims 10 through 15, wherein the method further comprises fabricating an aft dome comprising a third fiber reinforced thermoplastic, wherein the aft dome comprises a cylindrical portion and a hemispherical portion extending from the cylindrical portion and defining an aperture, and wherein forming the composite case further comprises forming the composite case over at least a portion of each of the aft dome, wherein at least a portion of the third fiber reinforced thermoplastic of the aft dome is consolidated with at least a portion of the second fiber reinforce thermoplastic of the composite case to define a second unitary interface.
Clause 17. The method of any one of claims 10 through 16, wherein the method further comprises: fabricating an aft dome comprising a third fiber reinforced thermoplastic, wherein the aft dome comprises a cylindrical portion and a hemispherical portion extending from the cylindrical portion and defining an aperture; and ultra sonic welding of at least a portion of the third fiber reinforced thermoplastic of the aft dome to at least a portion of the second fiber reinforce thermoplastic of the composite case to define a second unitary interface.
Clause 18. The method of any one of claims 10 through 17, wherein the method further comprises fabricating at least one attachment feature comprising a high strength metal or alloy, and wherein assembling further comprises positioning the at least one attachment feature on the mandrel.
Clause 19. A composite rocket case, comprising: aft dome comprising a first wound fiber reinforced thermoplastic; a forward dome comprising a second wound fiber reinforced thermoplastic; and a composite case comprising a third wound fiber reinforced thermoplastic defining a hollow cylinder extending from a proximal end to a distal end, wherein at least a first portion of the third wound fiber reinforced thermoplastic at the proximal end is consolidated with at least a portion of the first wound fiber reinforced thermoplastic to define a first unitary interface between the aft dome and the composite case, and wherein at least a second portion of the third wound fiber reinforced thermoplastic at the distal portion is consolidated with at least a portion of the second wound fiber reinforced thermoplastic to define a second unitary interface between the forward dome and the composite case.
Clause 20. The composite rocket case of claim 19, further comprising an insulator disposed within the hollow cylinder of the composite case, wherein the insulator comprises an EPDM impregnated tape arranged in a shingle ply, wherein the insulator defines a hollow cylinder extending from a proximal end to a distal end, wherein the aft dome extends from the proximal end of the insulator, and wherein the forward dome extends from the distal end of the insulator.
Clause 21. The composite rocket case of claim 19 or 20, further comprising a forward bracket comprising a ring having a diameter congruent with a diameter of the forward dome and a plurality of braces extending radially inward from the ring, wherein a radially inward surface of each brace defines a curve congruent with a curvature of the top of the forward dome.
Clause 22. The composite rocket case of any one of claims 19 through 21, further comprising an aft bracket comprising a ring having a diameter congruent with a diameter of the aft dome and a plurality of braces extending radially inward from the ring, wherein a radially inward surface of each brace defines a curve congruent with a curvature of the bottom of the aft dome.
Clause 23. The composite rocket case of any one of claims 19 through 22, further comprising at least one attachment feature comprising a nut plate and an interface, wherein the nut plate defines a surface bonded to at least a portion of the composite case, and wherein the nut plate defines a plurality of apertures configured to receive fasteners mounting the interface to the nut plate.
Clause 24. The composite rocket case of any one of claims 19 through 23, wherein the aft dome comprises a metal closure ring and a shim ply disposed on and extending from a circumferential surface of the metal closure ring, wherein a fiber reinforced thermoplastic of a shim ply is consolidated with the first wound fiber reinforced thermoplastic of the aft dome.
Clause 25. The composite rocket case of any one of claims 19 through 24, wherein a distal portion of the aft dome comprises a closure ring defining an orifice size to receive therethrough a cartridge of propellant.
Clause 26. The composite rocket case of any one of claims 19 through 25, wherein the forward dome comprises a polar boss.

While the disclosure has been described in connection with what is presently considered to be the most practical and preferred embodiments, it is to be understood that the disclosure is not to be limited to the disclosed embodiments, but on the contrary, is intended to cover various modifications and equivalent arrangements included within the spirit and scope of the appended claims, which scope is to be accorded the broadest interpretation so as to encompass all such modifications and equivalent structures as permitted under the law. Furthermore, it should be understood that while the use of the word preferable, preferably, or preferred in the description above indicates that feature so described may be more desirable, it nonetheless may not be necessary and any embodiment lacking the same may be contemplated as within the scope of the disclosure, that scope being defined by the claims that follow. In reading the claims it is intended that when words such as “a,” “an,” “at least one” and “at least a portion” are used, there is no intention to limit the claim to only one item unless specifically stated to the contrary in the claim. Further, when the language “at least a portion” and/or “a portion” is used the item may include a portion and/or the entire item unless specifically stated to the contrary.

What is claimed is:

1. A method of manufacturing a rocket motor, wherein the method comprises:
winding onto a first mandrel a first fiber reinforced thermoplastic to define a dome;
assembling the dome on a second mandrel to define an assembly; and
winding onto the assembly, by automated consolidating filament tape winding with at least one placement head, a second fiber reinforced thermoplastic to define a composite case, wherein the at least one placement head is configured to apply a consolidating force,
wherein, after winding the second fiber reinforced thermoplastic, at least a portion of the second fiber reinforced thermoplastic is consolidated with at least a portion of the first fiber reinforced thermoplastic to define a unitary interface between the dome and the composite case.

2. The method of claim 1, wherein the dome comprises an aft dome, wherein the method further comprises winding onto a third mandrel a third fiber reinforced thermoplastic to define a forward dome, wherein assembling the dome comprises assembling the aft dome and the forward dome on the second mandrel to define the assembly, wherein the portion of the second fiber reinforced thermoplastic is consolidated with the portion of the first fiber reinforced thermoplastic to define a first unitary interface between the aft dome and the composite case, and wherein at least a second portion of the second fiber reinforced thermoplastic is consolidated with at least a portion of the third fiber reinforced thermoplastic to define a second unitary interface between the forward dome and the composite case.

3. The method of claim 1, wherein the assembling comprises assembling the dome and at least one attachment feature on the second mandrel to define the assembly.

4. The method of claim 3, wherein the method further comprises three-dimensional printing a high strength metal or alloy to define the at least one attachment feature.

5. The method of claim 1, wherein the second mandrel comprises a solid propellant.

6. The method of claim 1, wherein the method further comprises winding onto the second mandrel a felt tape comprising at least one of a carbon fiber, a silica fiber, and an aramid fiber impregnated with an ethylene propylene diene terpolymer (EPDM) to define an insulator, and wherein the assembling comprises assembling the dome on the insulator to define the assembly.

7. The method of claim 6, wherein the winding onto the second mandrel further comprises winding the felt tape to form a shingle ply comprising a plurality of ridges and a plurality of valleys;
curing the EPDM to form a cured shingle ply; and
machining the cured shingle ply to remove at least a portion of the plurality of ridges.

8. The method of claim 6, wherein the method further comprises loading a cartridge of propellant into a cavity defined by the insulator.

9. A method of manufacturing a rocket motor, wherein the method comprises:
fabricating a forward dome comprising a first fiber reinforced thermoplastic, wherein the forward dome comprises a cylindrical portion and a hemispherical portion extending from the cylindrical portion;
assembling the forward dome on a mandrel; and
forming a composite case comprising a second fiber reinforced thermoplastic on the mandrel and over at least a portion of the forward dome, wherein at least a portion of the first fiber reinforced thermoplastic of the forward dome is consolidated with at least a portion of the second fiber reinforce thermoplastic of the composite case to define a unitary interface.

10. The method of claim 9, wherein forming the composite case comprises automated consolidating filament tape winding of the second fiber reinforced thermoplastic on the mandrel and over the portion of the forward dome.

11. The method of claim 9, wherein forming the composite case further comprises at least one of:
forming stiffening regions on at least a portion of the composite case; and
at least partially embedding within the second fiber reinforced thermoplastic at least one of an internal feature, an external feature, and a control wire.

12. The method of claim 9, wherein the method further comprises fabricating an insulator comprising a wound felt tape comprising at least one of a carbon fiber, a silica fiber, and an aramid fiber impregnated and ethylene propylene diene terpolymer (EPDM), wherein the insulator comprises a hollow cylinder extending along longitudinal axis from a proximal end to a distal end, wherein assembling the forward dome on the mandrel comprises assembling the forward dome on the insulator, and wherein at least a portion of the cylindrical portion of the forward dome overlaps at least a portion of the hollow cylinder of the insulator.

13. The method of claim 12, wherein fabricating the insulator comprises:
winding onto the mandrel the felt tape to form a shingle ply comprising a plurality of ridges and a plurality of valleys;
curing the EPDM to form a cured shingle ply; and
machining the cured shingle ply to remove at least a portion of the plurality of ridges.

14. The method of claim 9, wherein the method comprises, before forming the composite case, forming an adhesive layer on the mandrel.

15. The method of claim 9, wherein the method further comprises fabricating an aft dome comprising a third fiber reinforced thermoplastic, wherein the aft dome comprises a cylindrical portion and a hemispherical portion extending from the cylindrical portion and defining an aperture, and wherein forming the composite case further comprises forming the composite case over at least a portion of each of the aft dome, wherein at least a portion of the third fiber reinforced thermoplastic of the aft dome is consolidated with at least a portion of the second fiber reinforce thermoplastic of the composite case to define a second unitary interface.

16. The method of claim 9, wherein the method further comprises:
fabricating an aft dome comprising a third fiber reinforced thermoplastic, wherein the aft dome comprises a cylindrical portion and a hemispherical portion extending from the cylindrical portion and defining an aperture; and
ultra sonic welding of at least a portion of the third fiber reinforced thermoplastic of the aft dome to at least a portion of the second fiber reinforce thermoplastic of the composite case to define a second unitary interface.

17. The method of claim 9, wherein the method further comprises fabricating at least one attachment feature comprising a high strength metal or alloy, and wherein assembling further comprises positioning the at least one attachment feature on the mandrel.

18. A composite rocket case, comprising:
a dome comprising a first wound fiber reinforced thermoplastic; and
a composite case comprising a second wound fiber reinforced thermoplastic defining a hollow cylinder extending from a proximal end to a distal end, wherein at least a first portion of the third wound fiber reinforced thermoplastic at the proximal end is consolidated with a portion of the first wound fiber reinforced thermoplastic to define a first unitary interface between the dome and the composite case.

19. The composite rocket case of claim 18, wherein the dome comprises an aft dome, wherein the composite rocket case further comprises a forward dome comprising a second wound fiber reinforced thermoplastic, wherein at least a second portion of the third wound fiber reinforced thermoplastic at the distal end is consolidated with at least a portion of the second wound fiber reinforced thermoplastic to define a second unitary interface between the forward dome and the composite case.

20. The composite rocket case of claim 19, further comprising:
a forward bracket comprising a ring having a diameter congruent with a diameter of the forward dome and a plurality of braces extending radially inward from the ring, wherein a radially inward surface of each brace defines a curve congruent with a curvature of the top of the forward dome; and
an aft bracket comprising a ring having a diameter congruent with a diameter of the aft dome and a plurality of braces extending radially inward from the ring, wherein a radially inward surface of each brace defines a curve congruent with a curvature of the bottom of the aft dome.
